(19) United States
(12) Patent Application Publication
(10) Pub. No.: US 2010/0178501 A1
(43) Pub. Date: Jul. 15, 2010

(54) ADHESIVE COMPOSITION, FILM-LIKE ADHESIVE, ADHESIVE SHEET, AND SEMICONDUCTOR DEVICE MADE WITH THE SAME

(76) Inventors: Takashi Masuko, Ibaraki (JP); Masanobu Miyahara, Ibaraki (JP); Keisuke Okubo, Ibaraki (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/161,246

(22) PCT Filed: Jan. 23, 2007
(86) PCT No.: PCT/JP2007/050985

§ 371 Date: Jul. 17, 2008

(30) Foreign Application Priority Data
Jan. 23, 2006 (JP) 2006-013854
Jul. 19, 2006 (JP) 2006-197324

(51) Int. Cl. C08K 5/3417; B32B 27/00; B32B 27/32

(52) U.S. Cl. 428/355 N; 524/94; 522/75; 428/473.5; 523/461

(57) ABSTRACT

An adhesive composition that is capable of achieving a superior combination of process characteristics such as adherend fill properties (embedability) and low-temperature lamination properties, and semiconductor device reliability such as reflow resistance, as well as a film-like adhesive, an adhesive sheet that exhibits excellent process characteristics including ready releasability from dicing sheets, and a semiconductor device that exhibits excellent productivity, superior adhesive strength when heated and superior moisture resistance, all of which use the adhesive composition. The adhesive composition comprises (A) a thermoplastic resin, (B) a bisallylnadimide represented by a general formula (I) shown below, and (C) a bifunctional or higher (meth)acrylate compound.

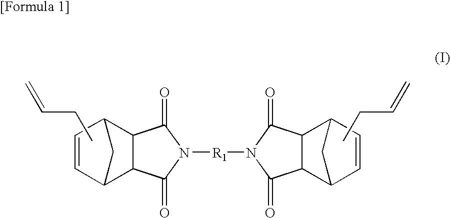

(wherein, R₁ represents a bivalent organic group containing an aromatic ring and/or a straight-chain, branched or cyclic aliphatic hydrocarbon).

### TECHNICAL FIELD

The present invention relates to an adhesive composition, a film-like adhesive, an adhesive sheet, and a semiconductor that uses the same.

### BACKGROUND ART

Conventionally, the bonding of semiconductor elements to support members used for mounting the semiconductor elements has predominantly employed silver pastes. However, recent trends to larger semiconductor elements, together with reductions in the size of, and improvements in the performance of, semiconductor packages have resulted in demands for similar reductions in the size of and improvements in the precision of the support members used. However, silver pastes are no longer able to fully satisfy these demands, due to problems including wire bonding defects caused by factors such as the spreading properties of the paste, paste protrusion, or tilting of the semiconductor element, difficulties in controlling the thickness of the silver paste, and the occurrence of voids within the silver paste. As a result, film-like adhesives have become more widely used in recent years, in order to satisfy the above demands (for example, see Japanese Patent Laid-Open No. H03-192178, and Japanese Patent Laid-Open No. 1104-234472).

These film-like adhesives are used in individual bonding systems or wafer backside bonding systems. When a semiconductor device is produced using a film-like adhesive of an individual bonding system, a film-like adhesive stored on a reel is first cut into individual sections using a cutting or punching technique, and one of these individual sections is then bonded to a support member. Subsequently, a semiconductor element that has undergone singulation by dicing is bonded to the support member bearing the film-like adhesive, thus preparing a semiconductor element bearing the support member. The semiconductor device is then obtained by conducting a wire bonding step and an encapsulation step (for example, see Japanese Patent Laid-Open No. H09-17810). However, in order to use a film-like adhesive for an individual bonding system, because a dedicated assembly device is required for cutting the film-like adhesive and bonding each individual section to a support member, the production costs are significantly higher than systems that use silver paste.

On the other hand, when a semiconductor device is produced using a film-like adhesive of a wafer backside bonding system, one surface of the film-like adhesive is first bonded to the backside of a semiconductor wafer, and a dicing sheet is then bonded to the other surface of the film-like adhesive. Subsequently, singulation of the semiconductor elements is performed by dicing the semiconductor wafer, and each single semiconductor element bearing the film-like adhesive is then picked up and bonded to a support member. The semiconductor device is then obtained by conducting a wire bonding step and an encapsulation step. With this type of film-like adhesive for a wafer backside bonding system, because a semiconductor element beating the film-like adhesive is bonded to the support member, a dedicated assembly device for performing singulation of the film-like adhesive is not required, meaning that bonding can be conducted either by using a conventional silver paste assembly apparatus without modification, or by using a conventional apparatus that has undergone partial modification such as the addition of a hotplate. As a result, this system is attracting considerable attention as an assembly method that uses a film-like adhesive and yet offers comparatively low production costs (for example, see Japanese Patent Laid-Open No. H04-196246).

However, recently, in addition to ongoing reductions in the size and thickness of semiconductor elements, and improvements in their performance, a trend towards multifunctionality has also become apparent, and this has resulted in a rapid increase in semiconductor devices comprising a plurality of semiconductor elements laminated together. On the other hand, because there remains an ongoing trend towards reducing the thickness of the semiconductor devices, the development of ultra thin semiconductor wafers is also progressing. As a result, wafer breakage during transport or wafer breakage during bonding of the film-like adhesive to the wafer backside is becoming increasingly problematic. In order to prevent such breakage, a technique in which a soft protective tape (typically a backgrind tape) is bonded to the wafer surface is increasingly being employed. However, because the softening temperature of the backgrind tape is typically not more than 100° C., and in order to suppress wafer warping caused by thermal stress during bonding, there are growing demands for a film-like adhesive that is capable of being bonded to the wafer backside at a temperature lower than 100° C.

Furthermore, in order to simplify the assembly process, a technique has been proposed in which bonding to the wafer backside is simplified by using an adhesive sheet comprising a dicing sheet bonded to one surface of a film-like adhesive, namely, a film that integrates the functions of a dicing sheet and a die bonding film (hereafter referred to as an integrated film). In order to produce this type of integrated film, a film-like adhesive is required which, in a similar manner to the backgrind tape described above, must be capable of being bonded to the wafer backside at a temperature lower than 100° C., and must also exhibit favorable process characteristics during semiconductor device assembly, including favorable pickup properties following dicing, namely, ready releasability following bonding to a dicing sheet.

Furthermore, semiconductor devices that use a film-like adhesive also require superior reliability, namely, superior levels of heat resistance, moisture resistance and reflow resistance. In order to ensure favorable reflow resistance, a high degree of adhesive strength capable of inhibiting peeling or breakdown of the die bonding layer at a reflow heating temperature of approximately 260° C. is required. In this manner, there are now strong demands for a film-like adhesive that is capable of favorably combining superior process characteristics, including low-temperature lamination properties, with superior reliability of the semiconductor device, including superior reflow resistance.

On the other hand, in those cases when the support member is an organic substrate with wiring formed on the surface, ensuring satisfactory fill properties (embedability) relative to the unevenness of the wiring is an important factor in ensuring reliable moisture resistance for the semiconductor device and reliable electrical insulation for wiring. This embedability can be achieved by employing the heat and pressure used during the transfer molding conducted in the encapsulation step of the semiconductor assembly process. However, as the above type of lamination of a plurality of semiconductor elements becomes more prevalent, the heat history processes (such as die bonding and wire bonding) required for bonding and laminating each semiconductor element tend to require more time as the number of laminated semiconductor element layers increases. Accordingly, in a semiconductor device comprising a plurality of laminated semiconductor elements, the film-like adhesive used in bonding the lowest level semiconductor element to the organic substrate having wiring unevenness is also subjected to the heat histories associated with laminating the upper level semiconductor elements, in the period between the die bonding and transfer molding steps. As a result, the fluidity deteriorates due to heat curing, and achieving the required embedability of the wiring unevenness on the substrate surface by employing the heat and pressure used during the transfer molding step may become problematic. If this embedability cannot be achieved, then deterioration in the moisture resistance reliability and the reflow resistance, caused by voids produced due to incomplete filling, becomes a concern. Accordingly, a film-like adhesive used in bonding the lowest level semiconductor element of a semiconductor device to the organic substrate having wiring unevenness should preferably exhibit favorable embedability of the wiring unevenness on the substrate surface at the point of bonding the semiconductor element to the organic substrate, namely at the die bonding step. In order to inhibit warping of the semiconductor element due to thermal stress and damage of the surface of the circuit on the semiconductor element, the heat and pressure applied during die bonding must be of a lower temperature and lower pressure than those employed during transfer molding, and must be applied for a shorter period. As a result, the film-like adhesive should preferably have sufficient fluidity when heated under these conditions to ensure favorable embedability of the wiring unevenness on the substrate surface, without suffering from foaming or void generation caused by incomplete filling.

In order to combine low-temperature processability with favorable heat resistance, a film-like adhesive comprising a combination of a thermoplastic resin with a comparatively low Tg value and a thermosetting resin has already been proposed (for example, see Japanese Patent Publication No. 3,014,578). However, a material that is capable of combining favorable fluidity when heated, which enables favorable embedability of wiring unevenness on a substrate surface under the conditions of low temperature, low pressure and a short time period described above, with favorable heat resistance at high temperatures including reflow resistance, and the design of such a material have still not been achieved entirely satisfactorily. Accordingly, more detailed and precise material design is required to enable a more favorable combination of the above types of properties to be achieved.

### DISCLOSURE OF INVENTION

As described above, resin compositions comprising a polyimide resin or acrylic rubber with a comparatively low Tg value and an epoxy resin have already been proposed as designs that are capable of combining low-temperature processability with heat resistance. Moreover, a design has also been proposed which, by increasing the blend ratio of an epoxy resin with a low molecular weight and a low viscosity, attempts to combine favorable fluidity when heated during the B-stage, which enables the embedding of wiring unevenness on a substrate surface under conditions of low temperature, low pressure and a short time period, with favorable heat resistance in the C-stage. However, as the quantity of the epoxy resin is increased, various problems arise, including an increase in the quantity of ionic impurities within the entire system, an increase in thermal stress, a deterioration in adhesiveness, and a deterioration in the heat resistance.

The present invention addresses the above problems associated with the conventional technology, and has an object of providing an adhesive composition and a film-like adhesive that are capable of achieving a superior combination of process characteristics such as adherend fill properties (embedability) and low-temperature lamination properties, and semiconductor device reliability such as reflow resistance.

Furthermore, another object of the present invention is to provide an adhesive sheet that exhibits excellent process characteristics, including the aforementioned ready releasability from dicing sheets.

Moreover, yet another object of the present invention is to provide a semiconductor device that exhibits excellent productivity, as well as superior adhesive strength when heated and superior moisture resistance.

As a result of intensive investigation aimed at achieving the above objects, the inventors of the present invention were able to develop the aspects described below. In other words, the characteristic features of the present invention are disclosed in the aspects <1> to <19> described below.

<1> An adhesive composition used for bonding a semiconductor element to an adherend, the composition comprising (A) a thermoplastic resin, (B) a bisallylnadimide represented by a general formula (I) shown below, and (C) a bifunctional or higher (meth)acrylate compound.

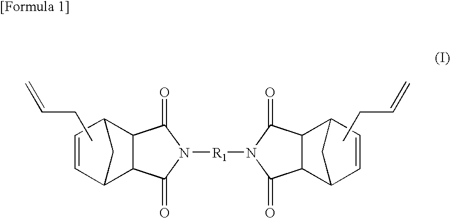

(wherein, R₁ represents a bivalent organic group containing an aromatic ring and/or a straight-chain, branched or cyclic aliphatic hydrocarbon)
<2> The adhesive composition according to the aspect <1>, wherein the bisallylnadimide (B) is represented by a structural formula (II) and/or structural formula (III) shown below.

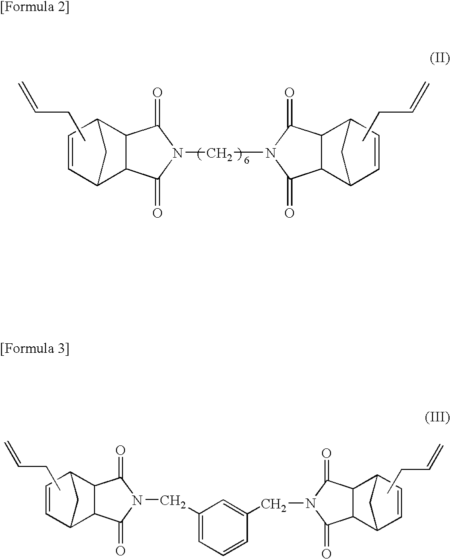

<3> The adhesive composition according to either the aspect <1> or <2>, wherein the bifunctional or higher (meth)acrylate compound (C) is represented by a structural formula (IV) shown below.

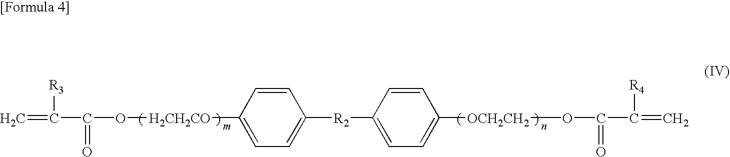

(wherein, R₂ represents a bivalent organic group, R₃ and R₄ each represent, independently, a hydrogen atom or a methyl group, and m and n represent integers of 1 or greater)
<4> The adhesive composition according to any one of the aspects <1> through <3>, further comprising: (D) a maleimide compound and/or a monofunctional condensed polycyclic oxazine compound.
<5> The adhesive composition according to the aspect <4>, wherein the maleimide compound is a bismaleimide compound represented by a general formula (V) shown below, or a novolak maleimide compound represented by a general formula (VI) shown below.

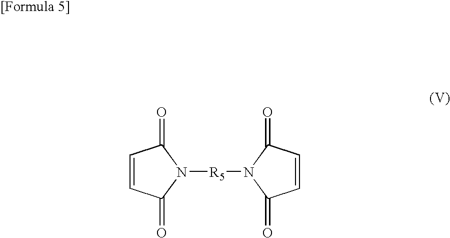

(wherein, R₅ represents a bivalent organic group containing an aromatic ring and/or a straight-chain, branched or cyclic aliphatic hydrocarbon)

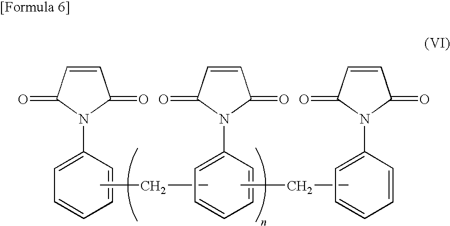

(wherein, n represents an integer from 0 to 20)
<6> The adhesive composition according to either the aspect <4> or <5>, wherein the monofunctional condensed polycyclic oxazine compound is a compound represented by a general formula (VII) shown below.

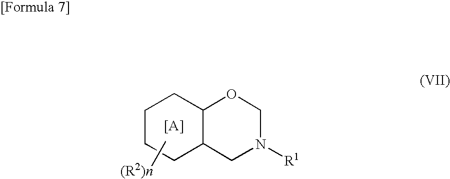

(wherein, [A] represents a monocyclic or condensed polycyclic aromatic hydrocarbon ring structure in which adjacent carbon atoms are shared with the oxazine ring to form a condensed ring structure, R¹ and R² are each selected, independently, from the group consisting of a hydrogen atom and substituted or unsubstituted monovalent hydrocarbon groups of 1 to 10 carbon atoms, all the R¹ and R² groups may be either the same or different, and n represents either 0, or an integer from 1 to 4)
<7> The adhesive composition according to the aspect <6>, wherein the monofunctional condensed polycyclic oxazine compound represented by the above general formula (VII) is a compound represented by a general formula (VIII) shown below.

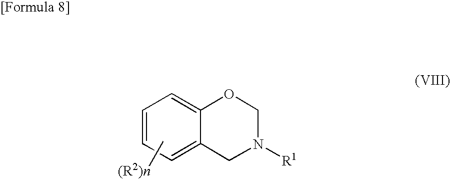

(wherein, R¹ and R² are each selected, independently, from the group consisting of a hydrogen atom and substituted or unsubstituted monovalent hydrocarbon groups of 1 to 10 carbon atoms, all the R¹ and R² groups may be either the same or different, and n represents either 0, or an integer from 1 to 4)
<8> The adhesive composition according to any one of the aspects <1> through <7>, further comprising: (E) an epoxy resin.
<9> The adhesive composition according to any one of the aspects <1> through <8>, further comprising: (F) a filler.
<10> The adhesive composition according to any one of the aspects <1> through <9>, wherein the thermoplastic resin (A) is a polyimide resin.
<11> The adhesive composition according to the aspect <10>, wherein the polyimide resin is a polyimide resin obtained by reacting a tetracarboxylic dianhydride with a diamine that comprises at least an aliphatic ether diamine represented by a formula (IXb) shown below.

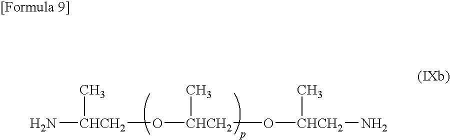

(wherein, p represents an integer from 0 to 80)
<12> The adhesive composition according to either the aspect <10> or <11>, wherein the Tg value for the polyimide resin is not higher than 100° C.
<13> The adhesive composition according to any one of the aspects <1> through <12>, further comprising: (G) a photoinitiator.
<14> The adhesive composition according to any one of the aspects <1> through <13>, wherein the adherend is an organic substrate having wiring unevenness.
<15> A film-like adhesive, formed using the adhesive composition according to any one of the aspects <1> through <14>.
<16> An adhesive sheet, having a structure comprising the film-like adhesive according to the aspect <15> and a dicing sheet laminated together.
<17> The adhesive sheet according to the aspect <16>, wherein the dicing sheet comprises a substrate film, and a radiation curable pressure sensitive adhesive layer provided on top of the substrate film.
<18> The adhesive sheet according to the aspect <16>, wherein the dicing sheet is a polyolefin-based film.
<19> A semiconductor device, having a structure in which a semiconductor element and a support member for mounting a semiconductor element, and/or a semiconductor element and another semiconductor element are bonded together using the adhesive composition according to any one of the aspects <1> through <14>, or the film-like adhesive according to the aspect <15>.

According to the present invention described above, a film-like adhesive for a wafer backside bonding system can be provided that is capable of accommodating ultra thin wafers and semiconductor devices comprising a plurality of laminated semiconductor elements. When a film-like adhesive is bonded to the backside of a wafer, the film-like adhesive is usually heated to a temperature that melts the adhesive, but by using the film-like adhesive of the present invention, bonding to the backside of the wafer can be conducted at a temperature that is lower than the softening temperature of a protective tape on an ultra thin wafer or a dicing tape used for bonding semiconductor elements together. As a result, thermal stress is reduced, and problems such as the warping of very large and very thin wafers can be addressed. Furthermore, the heat and pressure applied during die bonding is able to ensure a level of fluidity upon heating the film-like adhesive that enables favorable embedding of wiring unevenness on the substrate surface, meaning the film-like adhesive can be used favorably within production processes for semiconductor devices that comprise a plurality of laminated semiconductor elements. Furthermore, because the film-like adhesive also exhibits a high degree of adhesive strength at high temperatures, it yields improvements in the heat resistance and moisture resistance reliability, and is also able to simplify the production process for semiconductor devices. Moreover, by optimizing the adhesive composition, thermal stress problems such as wafer warping can be reduced even further, chip flying during dicing can be suppressed, and other properties such as the pickup properties, the workability during semiconductor device production, and the level of out gas can also be improved.

Furthermore, the present invention is also able to provide an adhesive sheet comprising the film-like adhesive described above bonded to a dicing sheet, wherein this adhesive sheet combines the functions of a dicing sheet and a die bonding film. According to the adhesive sheet of the present invention, even the bonding step of the dicing process can be simplified, and a material can be provided that enables stable properties to be retained even under the heat history accumulated during package assembly.

In addition, the present invention is also able to provide a semiconductor device that uses the film-like adhesive described above. The semiconductor device of the present invention is a semiconductor device of superior reliability that can be produced via a simplified production process. The semiconductor device of the present invention exhibits the heat resistance and moisture resistance required for those cases where semiconductor elements with large differences in the thermal expansion coefficient are mounted to a support member for mounting semiconductor elements.

This Application is based upon and claims the benefit of priority from prior Japanese Applications 2006-013854 (filed on Jan. 23, 2006) and 2006-197324 (filed on Jul. 19, 2006); the entire contents of which are incorporated by reference herein.

Furthermore, in the present invention, the expression “(meth)acrylate” refers to both the methacrylate and the acrylate.

### BRIEF DESCRIPTION OF THE DRAWINGS

FIG. 1 is a cross-sectional view showing an embodiment of a film-like adhesive of the present invention.

FIG. 2 is a cross-sectional view showing an embodiment of a film-like adhesive of the present invention.

FIG. 3 is a cross-sectional view showing an embodiment of a film-like adhesive of the present invention.

FIG. 4 is a cross-sectional view showing an embodiment of an adhesive sheet of the present invention.

FIG. 5 is a cross-sectional view showing an embodiment of an adhesive sheet of the present invention.

FIG. 6 is a schematic illustration showing an embodiment of a semiconductor device that uses a film-like adhesive of the present invention.

FIG. 7 is a schematic illustration showing an embodiment of a semiconductor device that uses a film-like adhesive of the present invention.

FIG. 8 is a schematic illustration showing a peel strength measuring apparatus.

### BEST MODE FOR CARRYING OUT THE INVENTION

An adhesive composition of the present invention comprises at least (A) a thermoplastic resin, (B) a bisallylnadimide represented by a general formula (I) shown below, and (C) a bifunctional or higher (meth)acrylate compound.

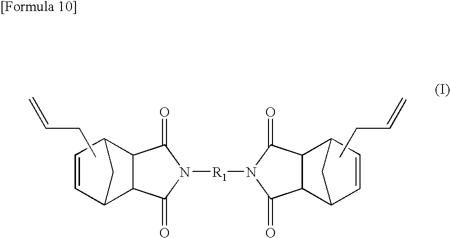

(wherein, R₁ represents a bivalent organic group containing an aromatic ring and/or a straight-chain, branched or cyclic aliphatic hydrocarbon)

The R₁ group in the above general formula (I) is preferably a benzene residue, toluene residue, xylene residue, naphthalene residue, a straight-chain, branched or cyclic alkyl group, or a mixture of these groups, and is even more preferably one or more bivalent organic groups represented by the structural formulas (Ia), (Ib) and (Ic) shown below.

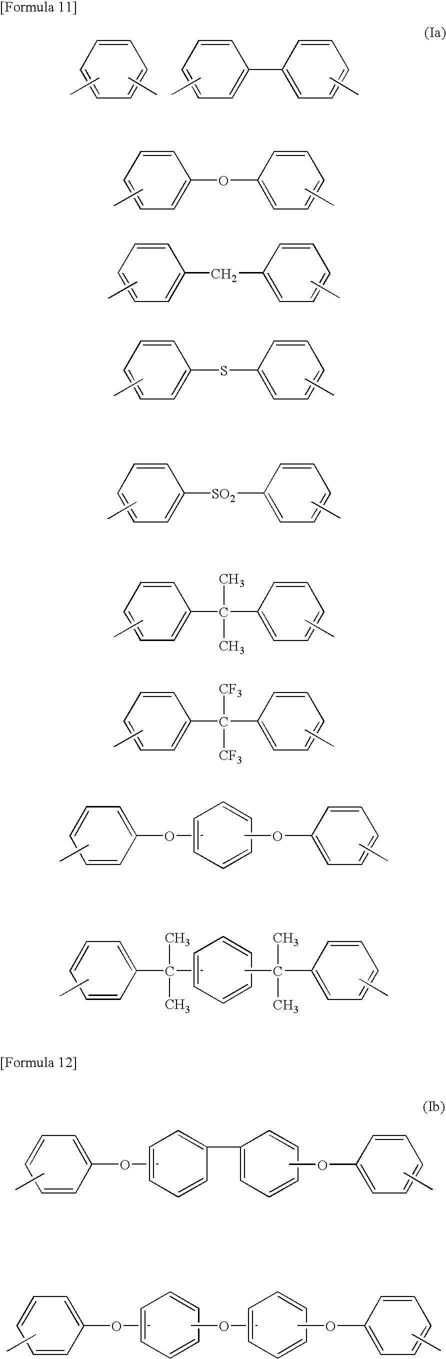

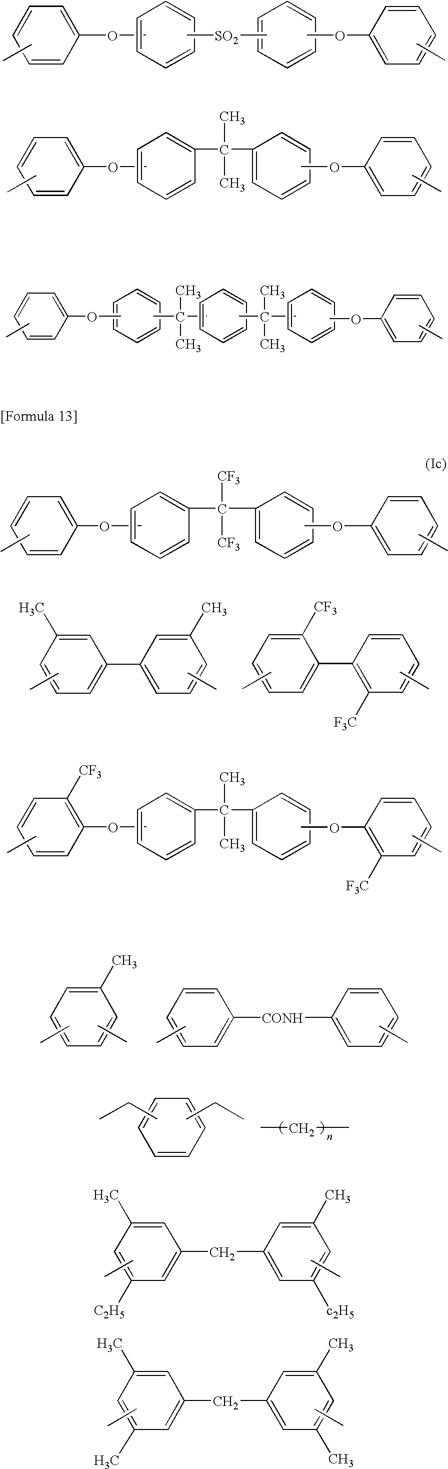

(wherein, n represents an integer from 1 to 10)

Of these, liquid hexamethylene-based bisallylnadimides represented by the structural formula (II) shown below, and low-melting point (melting point: approximately 40° C.) solid xylylene-based bisallylnadimides represented by the structural formula (III) shown below also function as co-solubilizers for the various other components that constitute the adhesive composition, and are therefore particularly preferred in terms of imparting favorable fluidity to the adhesive composition during heating in the B-stage. The solid xylylene-based bisallylnadimides not only impart favorable fluidity upon heating, but also suppress increases in the adhesiveness of the film surface at room temperature, thereby improving the handling properties of the adhesive. These bisallylnadimides may be used either alone, or in combinations of two or more different compounds.

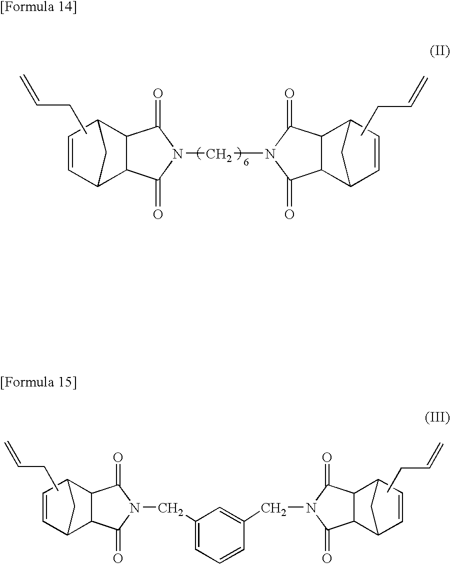

The bisallylnadimide (B) used in the present invention requires a curing temperature of 250° C. or higher in order to undergo unassisted curing without a catalyst, which represents a significant bather to its practical application. Furthermore, even in systems that include a catalyst, only catalysts such as strong acids or onium salts or the like can be used, and not only do these catalysts cause metal corrosion that represents a considerable drawback for use within electronic materials, they also require a temperature in the vicinity of 250° C. to achieve complete curing. As a result of intensive investigation aimed at reducing this curing temperature to a value of 200° C. or lower, the inventors discovered that by combining the bisallylnadimide with a bifunctional or higher (meth)acrylate compound (C) or with a maleimide compound described below, the above aim could be achieved. The details of these reaction mechanisms are not entirely clear, but they are thought to be due to a three dimensionalization of the product via an Ene reaction or a Diels-Alder reaction between the ally group of the bisallylnadimide, and the (meth)acrylate group within the (meth)acrylate compound or the maleimide group within the maleimide compound (see A. Renner, A. Kramer, “Allylnadic-Imides: A New Class of Heat-Resistant Thermosets”, J. Polym. Sci., Part A Polym. Chem., 27, 1301 (1989)).

Furthermore, in order to ensure an effective combination of favorable fluidity upon heating in the B-stage, and favorable heat resistance in the C-stage for the adhesive composition of the present invention, the blend quantity of the bisallylnadimide (B) is preferably within a range from 1 to 250 parts by weight, even more preferably from 5 to 200 parts by weight, and is most preferably from 10 to 100 parts by weight, per 100 parts by weight of the thermoplastic resin (A). If this blend quantity is less than 1 part by weight, then the effect of the present invention in combining the above properties tends to weaken, whereas if the quantity exceeds 250 parts by weight, the film-forming properties of the composition tend to be lost, both of which are undesirable.

There are no particular restrictions on the bifunctional or higher (meth)acrylate compound (C) used in the present invention, provided the compound contains two or more (meth)acrylic functional groups within each molecule, and specific examples include pentenyl acrylate, tetrahydrofurfuryl acrylate, diethylene glycol diacrylate, triethylene glycol diacrylate, tetraethylene glycol diacrylate, trimethylolpropane diacrylate, trimethylolpropane triacrylate, 1,4-butanediol diacrylate, 1,6-hexanediol diacrylate, polyethylene glycol diacrylate, ethylene oxide-modified neopentyl glycol acrylate, polypropylene glycol diacrylate, phenoxyethyl acrylate, tricyclodecanedimethylol diacrylate, ditrimethylolpropane tetraacrylate, pentaerythritol triacrylate, pentaerythritol tetraacrylate, dipentaerythritol hexaacrylate, tris(β-hydroxyethyl) isocyanurate triacrylate, pentenyl methacrylate, tetrahydrofurfuryl methacrylate, diethylene glycol dimethacrylate, triethylene glycol dimethacrylate, tetraethylene glycol dimethacrylate, trimethylolpropane dimethacrylate, trimethylolpropane trimethacrylate, 1,4-butanediol dimethacrylate, 1,6-hexanediol dimethacrylate, polyethylene glycol dimethacrylate, ethylene oxide-modified neopentyl glycol methacrylate, polypropylene glycol dimethacrylate, phenoxyethyl methacrylate, tricyclodecanedimethylol dimethacrylate, ditrimethylolpropane tetramethacrylate, pentaerythritol trimethacrylate, pentaerythritol tetramethacrylate, pentaerythritol hexamethacrylate, and tris(β-hydroxyethyl) isocyanurate trimethacrylate. Other examples besides the compounds listed above include bifunctional (meth)acrylates represented by the structural formula (IV) shown below, and of these, liquid bifunctional (meth)acrylates represented by the structural formula (IV) are preferred in terms of imparting favorable fluidity when heated in the B-stage. Specific examples of compounds of the structural formula (IV) shown below include bifunctional (meth)acrylates represented by a structural formula (IVa) shown below, and bifunctional (meth)acrylates represented by a structural formula (IVb) shown below. The above (meth)acrylate compounds may be used either alone, or in combinations of two or more different compounds.

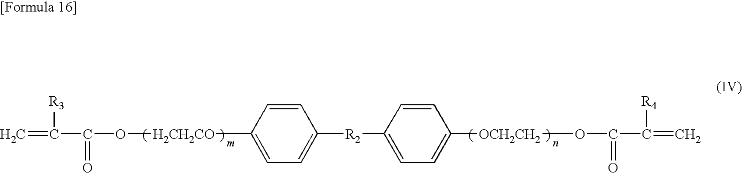

(wherein, R₂ represents a bivalent organic group, R₃ and R₄ each represent, independently, a hydrogen atom or a methyl group, and m and n represent integers of 1 or greater)

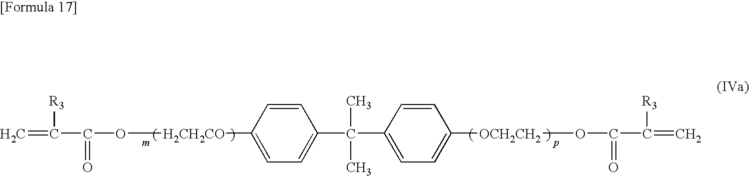

(wherein, R₃ represents a hydrogen atom or a methyl group, and m and p represent integers of 1 or greater)

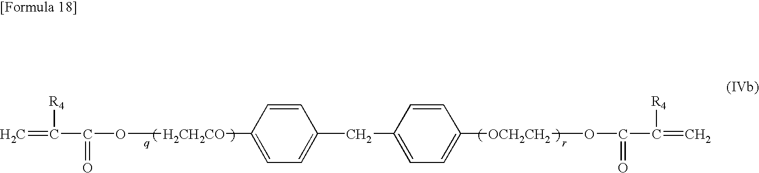

(wherein, R₄ represents a hydrogen atom or a methyl group, and q and r represent integers of 1 or greater)

Furthermore, the blend quantity of the above bifunctional or higher (meth)acrylate compound (C) is preferably within a range from 1 to 250 parts by weight, even more preferably from 5 to 200 parts by weight, and is most preferably from 10 to 100 parts by weight, per 100 parts by weight of the bisallylnadimide (B). If this blend quantity is less than 1 part by weight, then imparting the bisallylnadimide with low-temperature curability tends to become impossible, whereas if the quantity exceeds 250 parts by weight, the quantity of out gas tends to increase, and the heat resistance tends to deteriorate.

There are no particular restrictions on the thermoplastic resin (A) used in forming the adhesive composition of the present invention, and examples include one or more resins selected from the group consisting of polyimide resins, polyamide resins, polyamideimide resins, polyetherimide resins, polyurethaneimide resins, polyurethaneamideimide resins, siloxane polyimide resins, polyesterimide resins, copolymers of the above resins, as well as phenoxy resins, polysulfone resins, polyethersulfone resins, polyphenylene sulfide resins, polyester resins, polyetherketone resins, and (meth)acrylic copolymers having a weight average molecular weight within a range from 100,000 to 1,000,000. Of these, the use of polyimide resins is preferred.

The above polyimide resin can be obtained, for example, by subjecting a tetracarboxylic dianhydride and a diamine to a condensation reaction using a conventional method. In other words, a tetracarboxylic dianhydride and a diamine are subjected to an addition reaction in an organic solvent at a reaction temperature of not more than 80° C., and preferably within a range from 0 to 60° C., either using equimolar quantities of the tetracarboxylic dianhydride and diamine, or if necessary, with the ratio of the two components adjusted so that relative to 1.0 mols of the total quantity of the tetracarboxylic dianhydride, the total quantity of the diamine is within a range from 0.5 to 2.0 mols, and preferably from 0.8 to 1.0 mols (wherein the order of addition of the two components is arbitrary). As the reaction progresses, the viscosity of the reaction solution gradually increases, and a polyamic acid that represents a precursor to the polyimide is generated. In terms of the blend ratio between the tetracarboxylic dianhydride and the diamine, if the total quantity of the diamine exceeds 2.0 mols per 1.0 mols of the total quantity of the tetracarboxylic dianhydride, then the quantity of amine-terminated polyimide oligomers within the produced polyimide resin increases, whereas if the total quantity of the diamine is less than 0.5 mols, the quantity of acid-terminated polyimide oligomers increases, which tends to cause a reduction in the weight average molecular weight of the produced polyimide resin, as well as a deterioration in various properties of the resulting adhesive composition of the present invention, including the heat resistance. Furthermore, in those cases where the composition includes curable components such as epoxy resins that exhibit reactivity with the above terminals, an increase in the quantity of the types of polyimide oligomers described above tends to cause a worsening of the storage stability of the adhesive composition of the present invention, and this tendency is particularly marked with increases in the quantity of amine-terminated polyimide oligomers. As a result, the blend ratio should preferably not fall outside the above range. Moreover, as described below, epoxy resins also act as a cross-linking agent for polyimide resins, and particularly for polyimide oligomers, and therefore the blend ratio between the tetracarboxylic dianhydride and the diamine is preferably determined with due consideration of the properties required of the adhesive composition of the present invention. Furthermore, the molecular weight of the polyamic acid that functions as a precursor to the polyimide can be adjusted by conducting a depolymerization by heating at a temperature within a range from 50 to 80° C. The polyimide resin can be obtained by conducting a cyclodehydration of the above reaction product (the polyamic acid). The cyclodehydration can be conducted via a thermal cyclization method that involves a heat treatment, or a chemical cyclization method using a dehydration agent.

In order to inhibit deterioration in various properties of the adhesive composition of the present invention, prior to use, the acid dianhydride is preferably either dried by heating for 12 hours at a temperature that is 10 to 20° C. lower than the monomer melting point, or purified by recrystallization from acetic anhydride. As an indicator of the purity of the raw material, the difference between the endothermic start temperature and the endothermic peak temperature, as measured using a differential scanning calorimeter (DSC), is preferably not more than 10° C. The endothermic start temperature and the endothermic peak temperature refer to values measured using a DSC (a DSC-7 apparatus, manufactured by PerkinElmer, Inc.), under conditions including a nitrogen measurement atmosphere, a rate of temperature increase of 5° C./minute, and a sample amount of 5 mg.

There are no particular restrictions on the tetracarboxylic dianhydride used as a raw material for the above polyimide resin, and examples include pyromellitic dianhydride, 3,3′,4,4′-biphenyltetracarboxylic dianhydride, 2,2′,3,3′-biphenyltetracarboxylic dianhydride, 2,2-bis(3,4-dicarboxyphenyl)propane dianhydride, 2,2-bis(2,3-dicarboxyphenyl)propane dianhydride, 1,1-bis(2,3-dicarboxyphenyl)ethane dianhydride, 1,1-bis(3,4-dicarboxyphenyl)ethane dianhydride, bis(2,3-dicarboxyphenyl)methane dianhydride, bis(3,4-dicarboxyphenyl)methane dianhydride, bis(3,4-dicarboxyphenyl)sulfone dianhydride, 3,4,9,10-perylenetetracarboxylic dianhydride, bis(3,4-dicarboxyphenyl)ether dianhydride, benzene-1,2,3,4-tetracarboxylic dianhydride, 3,4,3′,4′-benzophenonetetracarboxylic dianhydride, 2,3,2′,3′-benzophenonetetracarboxylic dianhydride, 3,3,3′,4′-benzophenonetetracarboxylic dianhydride, 1,2,5,6-naphthalenetetracarboxylic dianhydride, 1,4,5,8-naphthalenetetracarboxylic dianhydride, 2,3,6,7-naphthalenetetracarboxylic dianhydride, 1,2,4,5-naphthalenetetracarboxylic dianhydride, 2,6-dichloronaphthalene-1,4,5,8-tetracarboxylic dianhydride, 2,7-dichloronaphthalene-1,4,5,8-tetracarboxylic dianhydride, 2,3,6,7-tetrachloronaphthalene-1,4,5,8-tetracarboxylic dianhydride, phenanthrene-1,8,9,10-tetracarboxylic, pyrazine-2,3,5,6-tetracarboxylic dianhydride, thiophene-2,3,5,6-tetracarboxylic dianhydride, 2,3,3′,4′-biphenyltetracarboxylic dianhydride, 3,4,3′,4′-biphenyltetracarboxylic dianhydride, 2,3,2′,3′-biphenyltetracarboxylic dianhydride, bis(3,4-dicarboxyphenyl)dimethylsilane dianhydride, bis(3,4-dicarboxyphenyl)methylphenylsilane dianhydride, bis(3,4-dicarboxyphenyl)diphenylsilane dianhydride, 1,4-bis(3,4-dicarboxyphenyldimethylsilyl)benzene dianhydride, 1,3-bis(3,4-dicarboxyphenyl)-1,1,3,3-tetramethyldicyclohexane dianhydride, p-phenylbis(trimellitate anhydride), ethylenetetracarboxylic dianhydride, 1,2,3,4-butanetetracarboxylic dianhydride, decahydronaphthalene-1,4,5,8-tetracarboxylic dianhydride, 4,8-dimethyl-1,2,3,5,6,7-hexahydronaphthalene-1,2,5,6-tetracarboxylic dianhydride, cyclopentane-1,2,3,4-tetracarboxylic dianhydride, pyrrolidine-2,3,4,5-tetracarboxylic dianhydride, 1,2,3,4-cyclobutanetetracarboxylic dianhydride, bis(exo-bicyclo[2,2,1]heptane-2,3-dicarboxylic dianhydride, bicyclo-[2,2,2]-oct-7-ene-2,3,5,6-tetracarboxylic dianhydride, 2,2-bis(3,4-dicarboxyphenyl)propane dianhydride, 2,2-bis[4-(3,4-dicarboxyphenyl)phenyl]propane dianhydride, 2,2-bis(3,4-dicarboxyphenyl)hexafluoropropane dianhydride, 2,2-bis[4-(3,4-dicarboxyphenyl)phenyl]hexafluoropropane dianhydride, 4,4′-bis(3,4-dicarboxyphenoxy)diphenyl sulfide dianhydride, 1,4-bis(2-hydroxyhexafluoroisopropyl)benzenebis(trimellitic anhydride), 1,3-bis(2-hydroxyhexafluoroisopropyl)benzenebis(trimellitic anhydride), 5-(2,5-dioxotetrahydrofuryl)-3-methyl-3-cyclohexene-1,2-dicarboxylic anhydride, tetrahydrofuran-2,3,4,5-tetracarboxylic dianhydride, 4,4′-oxydiphthalic dianhydride, tetracarboxylic dianhydrides represented by a structural formula (10) shown below, and tetracarboxylic dianhydride represented by a structural formula (11) shown below. Of these, in terms of imparting superior moisture resistance reliability, 4,4′-oxydiphthalic dianhydride or tetracarboxylic dianhydrides represented by the structural formula (11) shown below are preferred. These tetracarboxylic dianhydrides may be used either alone, or in combinations of two or more different compounds.

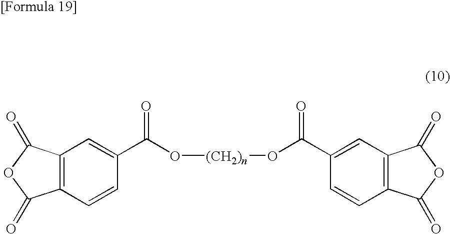

(wherein, n represents an integer from 2 to 20)

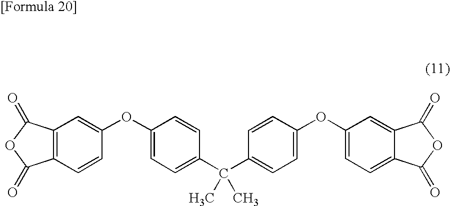

Furthermore, the tetracarboxylic dianhydrides of the above structural formula (10) can be synthesized, for example, from trimellitic anhydride monochloride and the corresponding diol. Examples of the trimellitic anhydride monochloride include 1,2-(ethylene)bis(trimellitate anhydride), 1,3-(trimethylene)bis(trimellitate anhydride), 1,4-(tetramethylene)bis(trimellitate anhydride), 1,5-(pentamethylene)bis(trimellitate anhydride), 1,6-(hexamethylene)bis(trimellitate anhydride), 1,7-(heptamethylene)bis(trimellitate anhydride), 1,8-(octamethylene)bis(trimellitate anhydride), 1,9-(nonamethylene)bis(trimellitate anhydride), 1,10-(decamethylene)bis(trimellitate anhydride), 1,12-(dodecamethylene)bis(trimellitate anhydride), 1,16-(hexadecamethylene)bis(trimellitate anhydride), and 1,18-(octadecamethylene)bis(trimellitate anhydride).

There are no particular restrictions on the aforementioned diamine used as a raw material for the above polyimide resin, and examples include aromatic diamines such as o-phenylenediamine, m-phenylenediamine, p-phenylenediamine, 3,3′-diaminodiphenyl ether, 3,4′-diaminodiphenyl ether, 4,4′-diaminodiphenyl ether, 3,3′-diaminodiphenylmethane, 3,4′-diaminodiphenylmethane, 4,4′-diaminodiphenylmethane, bis(4-amino-3,5-dimethylphenyl)methane, bis(4-amino-3,5-diisopropylphenyl)methane, 3,3′-diaminodiphenyldifluoromethane, 3,4′-diaminodiphenyldifluoromethane, 4,4′-diaminodiphenyldifluoromethane, 3,3′-diaminodiphenyl sulfone, 3,4′-diaminodiphenyl sulfone, 4,4′-diaminodiphenyl sulfone, 3,3′-diaminodiphenyl sulfide, 3,4′-diaminodiphenyl sulfide, 4,4′-diaminodiphenyl sulfide, 3,3′-diaminodiphenyl ketone, 3,4′-diaminodiphenyl ketone, 4,4′-diaminodiphenyl ketone, 2,2-bis(3-aminophenyl)propane, 2,2′-(3,4′-diaminodiphenyl)propane, 2,2-bis(4-aminophenyl)propane, 2,2-bis(3-aminophenyl)hexafluoropropane, 2,2-(3,4′-diaminodiphenyl)hexafluoropropane, 2,2-bis(4-aminophenyl)hexafluoropropane, 1,3-bis(3-aminophenoxy)benzene, 1,4-bis(3-aminophenoxy)benzene, 1,4-bis(4-aminophenoxy)benzene, 3,3′-(1,4-phenylenebis(1-methylethylidene))bisaniline, 3,4′-(1,4-phenylenebis(1-methylethylidene))bisaniline, 4,4′-(1,4-phenylenebis(1-methylethylidene))bisaniline, 2,2-bis(4-(3-aminophenoxy)phenyl)propane, 2,2-bis(4-(3-aminophenoxy)phenyl)hexafluoropropane, 2,2-bis(4-(4-aminophenoxy)phenyl)hexafluoropropane, bis(4-(3-aminophenoxy)phenyl)sulfide, bis(4-(4-aminophenoxy)phenyl)sulfide, bis(4-(3-aminophenoxy)phenyl)sulfone, and bis(4-(4-aminophenoxy)phenyl)sulfone, 3,3′-dihydroxy-4,4′-diaminobiphenyl and 3,5-diaminobenzoic acid; as well as 1,3-bis(aminomethyl)cyclohexane, 2,2-bis(4-aminophenoxyphenyl)propane, aliphatic ether diamines represented by a formula (IX) shown below, and specifically any of the aliphatic ether diamines represented by the structural formulas (IXa) shown below or aliphatic ether diamines represented by the formula (IXb) shown below, and aliphatic diamines represented by a structural formula (X) shown below.

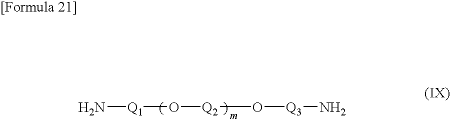

(wherein, Q₁, Q₂ and Q₃ each represent, independently, an alkylene group of 1 to 10 carbon atoms, and m represents an integer from 2 to 80)

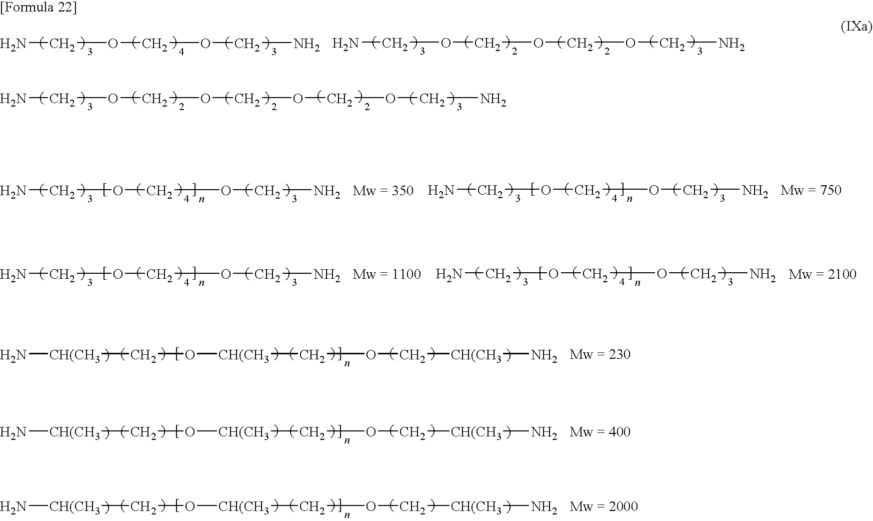

(wherein, n represents an integer from 2 to 80)

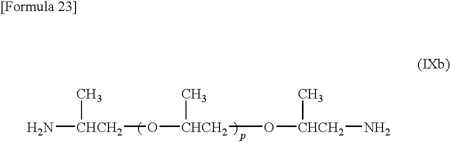

(wherein, p represents an integer from 0 to 80)

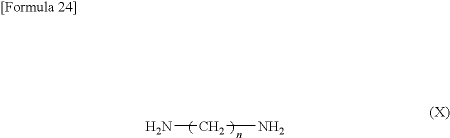

(wherein, n represents an integer from 5 to 20)

Specific examples of the aliphatic diamines represented by the above structural formula (X) include 1,2-diaminoethane, 1,3-diaminopropane, 1,4-diaminobutane, 1,5-diaminopentane, 1,6-diaminohexane, 1,7-diaminoheptane, 1,8-diaminooctane, 1,9-diaminononane, 1,10-diaminodecane, 1,11-diaminoundecane, 1,12-diaminododecane, and 1,2-diaminocyclohexane.

Furthermore, when determining the composition of the polyimide resin, the resin should preferably be designed so that the glass transition temperature (hereafter referred to as Tg) is not more than 100° C., and is even more preferably not more than 80° C., even more preferably within a range from −20 to 60° C., and most preferably within a range from −20 to 40° C. If this Tg value exceeds 100° C., then as described below, there is an increased likelihood of the bonding temperature to the wafer backside exceeding 80° C. In contrast, if the Tg value is lower than −20° C., then the surface of a film formed from the adhesive composition of the present invention exhibits overly powerful tack during the B-stage, meaning the handling properties tend to deteriorate. In order to ensure that this Tg value is not more than 100° C., the use of an aliphatic ether diamine represented by the above formula (IXb) as the diamine raw material for the polyimide resin is preferred. Specific examples include aliphatic ether diamines such as polyoxyalkylenediamines, including Jeffamine D-230, D-400, D-2000, D-4000, ED-600, ED-900, ED-2001 and EDR-148, manufactured by San Techno Chemical Co., Ltd., and Polyetheramine D-230, D-400 and D-2000, manufactured by BASF Corporation. In the case of aliphatic ether diamines represented by the above formula (IXb) in which p is 10 or greater, the blend quantity of this compound preferably represents from 1 to 80 mol %, and even more preferably from 5 to 60 mol %, of the total diamine quantity. If this quantity is less than 1 mol %, then imparting the adhesive composition of the present invention with the desired low-temperature adhesiveness and fluidity upon heating tends to become difficult, whereas if the quantity exceeds 80 mol %, the Tg value for the polyimide resin becomes overly low, increasing the possibility of the film losing its self-supporting characteristics. The Tg value represents the main dispersion peak temperature when the adhesive composition of the present invention is converted to a film, and is measured using a viscoelasticity analyzer RSA-2 manufactured by Rheometrics Inc., under conditions including a film sample size of 35 mm×10 mm×40 μm (thickness), a rate of temperature increase of 5° C./minute, a frequency of 1 Hz, and a measurement temperature range from −150 to 300° C., with the value of the tan δ peak temperature in the vicinity of Tg being measured and used as the main dispersion temperature.

Furthermore, a siloxane diamine represented by a general formula (12) shown below can also be used the aforementioned diamine.

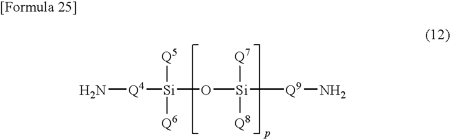

(wherein, Q⁴ and Q⁹ each represent, independently, an alkylene group of 1 to 5 carbon atoms or a phenylene group that may contain a substituent group, Q⁵, Q⁶, Q⁷ and Q⁸ each represent, independently, an alkyl group of 1 to 5 carbon atoms, a phenyl group or a phenoxy group, and p represents an integer from 1 to 5)

Specific examples of these siloxane diamines, <for those cases where p is 1> in the formula (12), include 1,1,3,3-tetramethyl-1,3-bis(4-aminophenyl)disiloxane, 1,1,3,3-tetraphenoxy-1,3-bis(4-aminoethyl)disiloxane, 1,1,3,3-tetraphenyl-1,3-bis(2-aminoethyl)disiloxane, 1,1,3,3-tetraphenyl-1,3-bis(3-aminopropyl)disiloxane, 1,1,3,3-tetramethyl-1,3-bis(2-aminoethyl)disiloxane, 1,1,3,3-tetramethyl-1,3-bis(3-aminopropyl)disiloxane, 1,1,3,3-tetramethyl-1,3-bis(3-aminobutyl)disiloxane, and 1,3-dimethyl-1,3-dimethoxy-1,3-bis(4-aminobutyl)disiloxane; and <for those cases where p is 2>, include 1,1,3,3,5,5-hexamethyl-1,5-bis(4-aminophenyl)trisiloxane, 1,1,5,5-tetraphenyl-3,3-dimethyl-1,5-bis(3-aminopropyl)trisiloxane, 1,1,5,5-tetraphenyl-3,3-dimethoxy-1,5-bis(4-aminobutyl)trisiloxane, 1,1,5,5-tetraphenyl-3,3-dimethoxy-1,5-bis(5-aminopentyl)trisiloxane, 1,1,5,5-tetramethyl-3,3-dimethoxy-1,5-bis(2-aminoethyl)trisiloxane, 1,1,5,5-tetramethyl-3,3-dimethoxy-1,5-bis(4-aminobutyl)trisiloxane, 1,1,5,5-tetramethyl-3,3-dimethoxy-1,5-bis(5-aminopentyl)trisiloxane, 1,1,3,3,5,5-hexamethyl-1,5-bis(3-aminopropyl)trisiloxane, 1,1,3,3,5,5-hexaethyl-1,5-bis(3-aminopropyl)trisiloxane and 1,1,3,3,5,5-hexapropyl-1,5-bis(3-aminopropyl)trisiloxane.

The various diamines described above may be used either alone, or in combinations of two or more different compounds. Moreover, the various polyimide resins obtained from the various acid dianhydrides and diamines described above may also be used either alone, or if required, in mixtures (blends) containing two or more different resins.

The weight average molecular weight of the polyimide resin is preferably controlled within a range from 10,000 to 200,000, even more preferably from 10,000 to 100,000, and most preferably from 20,000 to 80,000. Provided the weight average molecular weight of the polyimide resin falls within the range from 10,000 to 200,000, the strength, flexibility and tack obtained when the adhesive composition of the present invention containing the polyimide resin is converted into a sheet-like or film-like form are all satisfactory, and the fluidity upon heating is also suitable, meaning favorable embedability of wiring unevenness on substrate surfaces can be achieved. If the weight average molecular weight is less than 10,000, then the film-forming properties of the composition tend to deteriorate, and the strength of the resulting film tends to decrease. In contrast, if the weight average molecular weight exceeds 200,000, then the fluidity upon heating worsens, and the embedability of unevenness on the substrate surface tends to deteriorate, both of which are undesirable. The weight average molecular weight described above refers to the weight average molecular weight value obtained when measurement is conducted by high performance liquid chromatography (using a C-RA4 apparatus, manufactured by Shimadzu Corporation) and the result is referenced against polystyrene standards.

As described above, provided the polyimide resin used as the thermoplastic resin (A) has a Tg value of not more than 100° C. and a weight average molecular weight within a range from 10,000 to 200,000, then not only can the bonding temperature be kept low when bonding an adhesive sheet or film-like adhesive, formed from the adhesive composition of the present invention containing the polyimide resin, to the backside of a wafer, but the heating temperature during adhesion and securing of a semiconductor element to a support member for mounting the semiconductor element (namely, the die bonding temperature) can also be reduced, enabling suppression of any increases in warping of the semiconductor element. Moreover, fluidity can be effectively imparted to the adhesive during die bonding. Furthermore, in those cases where the support member for mounting the semiconductor element is an organic substrate, sufficient strength can be provided to suppress the vapor pressure caused by gasification of the moisture content within the organic substrate at the heating temperature used during die bonding, thereby inhibiting foaming of the die bonding layer caused by this vapor pressure.

In addition to the essential components (A), (B) and (C) described above, the adhesive composition of the present invention preferably also comprises: (D) a maleimide compound and/or a monofunctional condensed polycyclic oxazine compound.

Although there are no particular restrictions on the maleimide compound, compounds containing two maleimide groups within each molecule are preferred, and examples include bismaleimide compounds represented by a general formula (V) shown below, and novolak maleimide compounds represented by a general formula (VI) shown below.

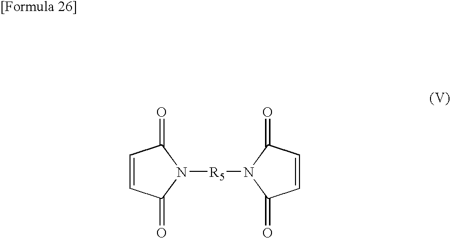

(wherein, R₅ represents a bivalent organic group containing an aromatic ring and/or a straight-chain, branched or cyclic aliphatic hydrocarbon)

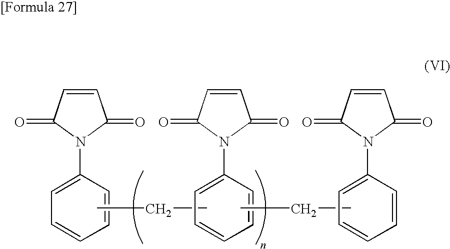

(wherein, n represents an integer from 0 to 20)

The R⁵ group in the above general formula (V) may be any bivalent organic group containing an aromatic ring and/or a straight-chain, branched or cyclic aliphatic hydrocarbon, and although there are no particular restrictions, preferred examples include a benzene residue, toluene residue, xylene residue, naphthalene residue, a straight-chain, branched or cyclic alkyl group, or a mixture of these groups, and particularly preferred groups include one or more bivalent organic groups represented by the structural formulas (Ia), (Ib) and (Ic) shown above, or one of the structural formulas (Id) shown below.

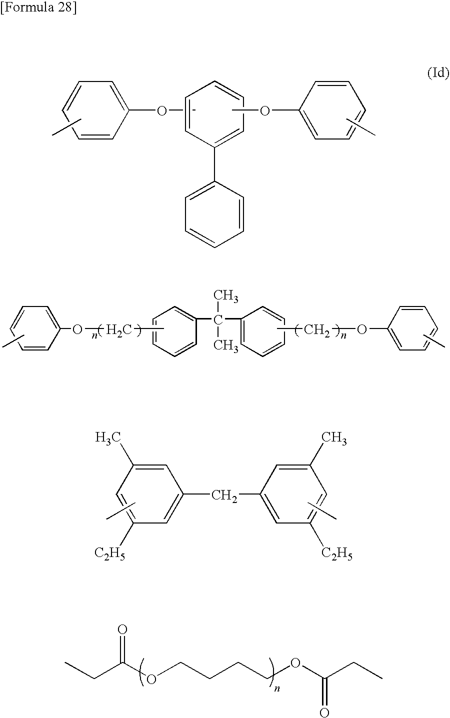

(wherein, n represents an integer from 1 to 10)

Of the above possibilities, in terms of effectively imparting favorable heat resistance and high-temperature adhesive strength to the adhesive composition of the present invention in the C-stage, the use of a bismaleimide compound represented by the structural formula (Va) shown below and/or a novolak maleimide compound represented by the above general formula (VI) is preferred.

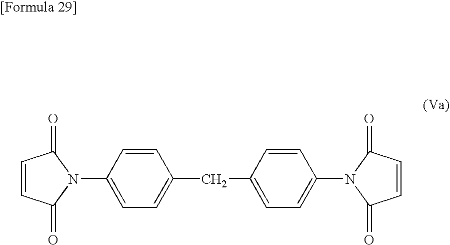

Furthermore, in order to ensure curing of the above maleimide compound, an allylated bisphenol A or a cyanate ester compound may be used in combination, or a catalyst such as a peroxide may be added. The quantity added of this compound or catalyst added to ensure curing, and the decision as to whether or not to add the compound or catalyst, should be determined so as to ensure the desired properties are obtained.

Furthermore, the monofunctional condensed polycyclic oxazine compound described above refers to a compound represented by a general formula (VII) shown below.

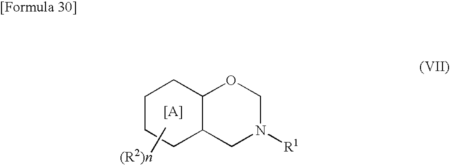

(wherein, [A] represents a monocyclic or condensed polycyclic aromatic hydrocarbon ring structure in which adjacent carbon atoms are shared with the oxazine ring to form a condensed ring structure, R¹ and R² are each selected, independently, from the group consisting of a hydrogen atom and substituted or unsubstituted monovalent hydrocarbon groups of 1 to 10 carbon atoms, all the R¹ and R² groups may be either the same or different, and n represents either 0, or an integer from 1 to 4)

Examples of the monocyclic or condensed polycyclic aromatic hydrocarbon ring structure in which adjacent carbon atoms are shared with the oxazine ring to form a condensed ring structure, as represented by [A] in the general formula (VII), include a benzene ring, naphthalene ring and anthracene ring, and of these, a benzene ring is particularly preferred. Examples of R¹ and R² include a hydrogen atom, chain-like alkyl groups such as a methyl group, ethyl group, propyl group, isopropyl group, n-butyl group, sec-butyl group, t-butyl group, pentyl group, hexyl group, octyl group, decyl group or dodecyl group, cyclic alkyl groups such as a cyclopentyl group, cyclohexyl group, cycloheptyl group, cyclopentenyl group or cyclohexenyl group, aryl-substituted alkyl groups such as a benzyl group or phenethyl group, alkoxy-substituted alkyl groups such as methoxy-substituted alkyl groups, ethoxy-substituted alkyl groups and butoxy-substituted alkyl groups, amino-substituted groups such as a dimethylamino group or diethylamino group, hydroxyl-substituted alkyl groups, alkenyl groups such as a vinyl group, allyl group or butenyl group, unsubstituted aryl groups such as a phenyl group, naphthyl group or biphenyl group, alkyl-substituted aryl groups such as a tolyl group, dimethylphenyl group, ethylphenyl group, butylphenyl group, t-butylphenyl group or dimethylnaphthyl group, and alkoxy-substituted aryl groups such as a methoxyphenyl group, ethoxyphenyl group, butoxyphenyl group, t-butoxyphenyl group or methoxynaphthyl group, and of these, a hydrogen atom, methyl group, phenyl group, tolyl group or allyl group is preferred. Furthermore, in the general formula (VII), n represents either 0 or an integer from 1 to 4, and is preferably either 0 or 1.

Preferred structures for the monofunctional condensed polycyclic oxazine compound include those represented by a general formula (VIII) shown below, and specific examples include the compounds of structural formulas (1) to (9) shown below.

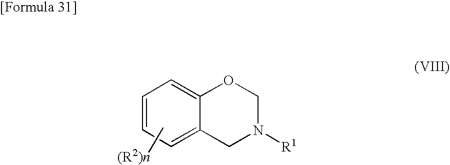

(wherein, R¹ and R² are each selected, independently, from the group consisting of a hydrogen atom and substituted or unsubstituted monovalent hydrocarbon groups of 1 to 10 carbon atoms, all the R¹ and R² groups may be either the same or different, and n represents either 0, or an integer from 1 to 4)

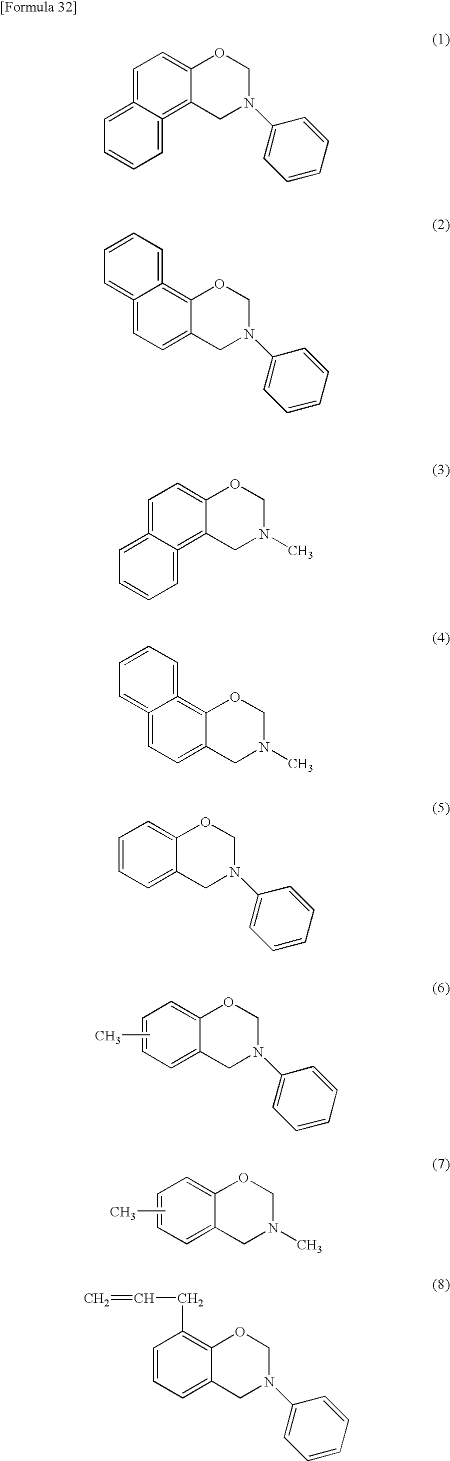

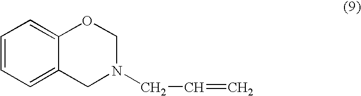

The above monofunctional condensed polycyclic oxazine compound can be synthesized using conventional methods, from a monocyclic or condensed polycyclic phenol having a single phenolic hydroxyl group within each molecule, in which at least one of the ortho positions relative to the hydroxyl group is unsubstituted, formaldehyde, and a primary amine having a single amino group within each molecule. For example, a method may be used in which the phenol is dissolved in a solvent such as dioxane, toluene, methanol or ethylene glycol dim ethyl ether, and the primary amine and formaldehyde are then added to the solution. The reaction usually proceeds without a catalyst, but if required, a hydroxide of an alkali metal or alkaline earth metal, or a tertiary amine or the like may be used as a catalyst. The blend ratio of the raw materials is set such that phenol/primary amine/formaldehyde=1/1/2 (molar ratio), and the reaction is conducted at a reaction temperature of 60 to 120° C. for a period of 2 to 24 hours. After a certain period of time has elapsed, the organic layer that represents the reaction product and the water of condensation produced from the reaction are removed from the system by distillation or the like, thus yielding the target monofunctional condensed polycyclic oxazine compound.

In those cases where a maleimide compound and/or a monofunctional condensed polycyclic oxazine compound (D) is used, the total quantity of the maleimide compound and/or a monofunctional condensed polycyclic oxazine compound (D) is preferably within a range from 1 to 200 parts by weight, even more preferably from 5 to 100 parts by weight, and is most preferably from 10 to 80 parts by weight, per 100 parts by weight of the thermoplastic resin (A). If this blend quantity is less than 1 part by weight, then imparting effective C-stage heat resistance tends to be difficult, whereas if the quantity exceeds 200 parts by weight, the film-forming properties of the composition tend to be lost.

The adhesive composition of the present invention preferably also comprises an epoxy resin (E). Although there are no particular restrictions on the epoxy resin (E), resins containing at least two epoxy groups within each molecule are preferred, and in terms of the curability and the properties of the resulting cured product, phenol glycidyl ether-based epoxy resins are particularly desirable. Specific examples include bisphenol A (or AD, S or F) glycidyl ethers, hydrogenated bisphenol A glycidyl ethers, glycidyl ethers of ethylene oxide adducts of bisphenol A, glycidyl ethers of propylene oxide adducts of bisphenol A, glycidyl ethers of phenol novolak resins, glycidyl ethers of cresol novolak resins, glycidyl ethers of bisphenol A novolak resins, glycidyl ethers of naphthalene resins, trifunctional (or tetrafunctional) glycidyl ethers, glycidyl ethers of dicyclopentadienephenol resins, glycidyl esters of dimer acid, trifunctional (or tetrafunctional) glycidyl amines, and glycidyl amines of naphthalene resins. These resins may be used either alone, or in combinations of two or more different resins. Furthermore, ensuring that these epoxy resins are high-purity resins in which the quantity of impurity ions, including alkali metal ions, alkaline earth metal ions and halogen ions, and particularly chloride ions and hydrolyzable chlorine and the like, is reduced to not more than 300 ppm is preferred in terms of preventing electromigration and preventing corrosion of metal conductive circuits.

Furthermore, in those cases where an aforementioned polyimide resin is used as the thermoplastic resin (A), the epoxy resin (E) undergoes reaction, under heat, with the acid or amine reactive terminal groups of oligomer components incorporated within the polyimide resin, meaning the epoxy resin also acts as a cross-linking agent for the polyimide resin. Accordingly, if a polyimide resin is selected as the thermoplastic resin (A), then adding an epoxy resin (E) in addition to the bisallylnadimide (B) and the bifunctional or higher acrylate compound (C) is preferred, as it enables the required cross-linking density to be achieved during the C-stage, enabling favorable high-temperature adhesiveness to be imparted to the adhesive composition of the present invention. Furthermore, in order to ensure favorable fluidity upon heating during the B-stage for the adhesive composition of the present invention, a liquid epoxy resin is preferably selected and used as the epoxy resin (E). The blend quantity of the epoxy resin (E) is preferably within a range from 0.01 to 200 parts by weight, even more preferably from 1 to 100 parts by weight, and most preferably from 5 to 50 parts by weight, per 100 parts by weight of the thermoplastic resin (A). If this blend quantity is less than 0.01 parts by weight, then the effect of the epoxy resin in raising the high-temperature adhesive strength tends to be difficult to achieve, whereas if the quantity exceeds 200 parts by weight, then the film-forming properties deteriorate, the quantity of ionic impurities within the overall system tends to increase, the quantity of out gas upon heating tends to increase, and the adhesiveness also tends to deteriorate.

In those cases where an epoxy resin (E) is used, a curing agent may also be used if required, and this enables suppression of out gas upon heating, which can cause contamination of the semiconductor elements or device when heating is conducted during assembly of the semiconductor device. Examples of this curing agent include phenol-based compounds, aliphatic amines, alicyclic amines, aromatic polyamines, polyamides, aliphatic acid anhydrides, alicyclic acid anhydrides, aromatic acid anhydrides, dicyandiamide, organic acid dihydrazides, boron trifluoride amine complexes, imidazoles and tertiary amines, and of these, phenol-based compounds are preferred, and phenol-based compounds having at least two phenolic hydroxyl groups within each molecule are particularly desirable. Examples of these types of phenol-based compounds include phenol novolak resins, cresol novolak resins, t-butylphenol novolak resins, dicyclopentadienecresol novolak resins, dicyclopentadienephenol novolak resins, xylylene-modified phenol novolak resins, naphthol-based compounds, trisphenol-based compounds, tetrakisphenol novolak resins, bisphenol A novolak resins, poly-p-vinylphenol resins and phenol aralkyl resins, and of these, compounds with a number average molecular weight within a range from 400 to 1,500 are preferred. In order to ensure favorable heat resistance for the cured product of the adhesive composition of the present invention, the blend quantity of the phenol-based compound is preferably sufficient that the equivalence ratio between the epoxy equivalent weight of the epoxy resin and the OH equivalent weight of the phenol-based compound is within a range from 0.95 to 1.05:0.95 to 1.05.

Furthermore, a curing accelerator may also be used if required. There are no particular restrictions on this curing accelerator, provided it accelerates the curing of the thermosetting resin, and conventional compounds may be used. Examples include imidazoles, dicyandiamide derivatives, dicarboxylic acid dihydrazides, triphenylphosphine, tetraphenylphosphonium tetraphenylborate, 2-ethyl-4-methylimidazole tetraphenylborate, and 1,8-diazabicyclo[5.4.0]undecene-7-tetraphenylborate.

Moreover, a filler (F) may also be added to the adhesive composition of the present invention. Examples of this filler include metal fillers such as silver powder, gold powder, copper powder and nickel powder, inorganic fillers such as alumina, aluminum hydroxide, magnesium hydroxide, calcium carbonate, magnesium carbonate, calcium silicate, magnesium silicate, calcium oxide, magnesium oxide, aluminum oxide, aluminum nitride, crystalline silica, amorphous silica, boron nitride, titania, glass, iron oxide and ceramics, and organic fillers such as carbon and rubber-based fillers, and any of these fillers can be used without any particular restrictions, regardless of the nature or shape of the filler.

The above fillers (F) can be selected in accordance with the functions required of the adhesive composition. For example, metal fillers are added for purposes such as imparting conductivity, thermal conductivity or thixotropic properties or the like to the adhesive composition, non-metallic inorganic fillers are added for purposes such as imparting thermal conductivity, low thermal expansion properties or low moisture absorption properties or the like to the adhesive composition, and organic fillers are added for purposes such as imparting toughness and the like to the adhesive composition. These metal fillers, inorganic fillers or organic fillers may be used either alone, or in combinations of two or more different fillers. Of the above fillers, in terms of imparting the conductivity, thermal conductivity, low moisture absorption properties and insulating properties required of an adhesive material for a semiconductor device, the use of a metal filler, inorganic filler or insulating filler is preferred, and of the various inorganic fillers and insulating fillers, boron nitride is particularly preferred as it exhibits favorable dispersibility within resin varnishes, and is effective in imparting a powerful adhesive strength upon heating.

The average particle size of the above filler (F) is preferably not more than 10 μm with a maximum particle size of not more than 25 μm, and the average particle size is even more preferably not more than 5 μm with a maximum particle size of not more than 20 μm. If the average particle size exceeds 10 μm and the maximum particle size exceeds 25 μm, then the effect of the filler in improving the fracture toughness tends to be unobtainable. Although there are no particular restrictions on the lower limit for the average particle size and the maximum particle size, a value of 1 nm is typical for both. The filler (F) preferably satisfies both the requirements for an average particle size of not more than 10 μm and a maximum particle size of not more than 25 μm. If a filler is used for which the maximum particle size is not more than 25 μm but the average particle size exceeds 10 μm, then a high degree of adhesive strength tends to be unobtainable. Furthermore, in contrast, if a filler is used for which the average particle size is not more than 10 μm but the maximum particle size exceeds 25 μm, then the particle size distribution broadens, and the adhesive strength tends to be prone to fluctuation. Furthermore, in the present invention, when the adhesive composition is formed as a thin film and then used, the surface tends to be rougher, and the adhesive strength tends to deteriorate. The average particle size and maximum particle size of the filler can be measured, for example, using a scanning electron microscope (SEM), by measuring the particle sizes of approximately 200 particles of the filler. An example of a measurement method using a SEM is a method in which a sample is prepared by forming a film from the adhesive composition, this film is used to bond a semiconductor element to a support substrate for mounting the semiconductor element, heat curing (preferably by heating at 150 to 200° C. for 1 to 10 hours) is then conducted, and the central portion of the sample is then cut and the resulting cross-section is inspected using the SEM. At this time, the existence probability of a filler that satisfies both of the above particle size conditions is preferably 80% or more of the total quantity of filler.

The blend quantity of the above filler (F) can be determined in accordance with the properties and functions imparted by the filler to the adhesive composition of the present invention, but is typically sufficient to represent from 1 to 50% by volume, preferably from 2 to 40% by volume, and even more preferably from 5 to 30% by volume, of the combined quantity of the resin component and the filler. By increasing the quantity of the filler, the elastic modulus can be increased, enabling effective improvements in the dicing properties (the cutting characteristics upon cutting with a dicing blade), the wire bonding properties (the ultrasound efficiency), and the adhesive strength upon heating. However, if the quantity of filler is increased beyond what is necessary, then the low-temperature bonding properties and interface adhesion with the adherend, which represent features of the present invention, tend to deteriorate, and the reliability including the reflow resistance also tends to worsen, and consequently the quantity used of the filler is preferably kept within the above range. The optimum quantity of the filler for achieving the best balance between the required properties is preferably determined. Furthermore, in those cases where a filler is added, mixing or kneading of the filler can be conducted using a stirrer or dispersion device such as a stone mill, three-roll mill, ball mill or a combination thereof.

Furthermore, if required, a photoinitiator (G) may also be added to the adhesive composition of the present invention. This photoinitiator (G) may be a photopolymerization initiator that generates free radicals upon irradiation, a photobase generator that generates a base upon irradiation, or a similar initiator.

Examples of the photopolymerization initiators include aromatic ketones such as benzophenone, N,N′-tetramethyl-4,4′-diaminobenzophenone (Michler's ketone), N,N′-tetraethyl-4,4′-diaminobenzophenone, 4-methoxy-4′-dimethylaminobenzophenone, 2-benzyl-2-dimethylamino-1-(4-morpholinophenyl)-butanone-1,2,2-dimethoxy-1,2-diphenylethan-1-one, 1-hydroxycyclohexyl phenyl ketone, 2-methyl-1-(4-(methylthio)phenyl)-2-morpholinopropanone-1, 2,4-diethylthioxanthone, 2-ethylanthraquinone and phenanthrenequinone, benzoin ethers such as benzoin methyl ether, benzoin ethyl ether and benzoin phenyl ether, benzoins such as methylbenzoin and ethylbenzoin, benzil derivatives such as benzil dimethyl ketal, 2,4,5-triarylimidazole dimers such as 2-(o-chlorophenyl)-4,5-diphenylimidazole dimer, 2-(o-chlorophenyl)-4,5-di(m-methoxyphenyl)imidazole dimer, 2-(o-fluorophenyl)-4,5-phenylimidazole dimer, 2-(o-methoxyphenyl)-4,5-diphenylimidazole dimer, 2-(p-methoxyphenyl)-4,5-diphenylimidazole dimer, 2,4-di(p-methoxyphenyl)-5-phenylimidazole dimer and 2-(2,4-dimethoxyphenyl)-4,5-diphenylimidazole dimer, and acridine derivatives such as 9-phenylacridine and 1,7-bis(9-acridinyl)heptane. These compounds may be used either alone, or in combinations of two or more different compounds. Furthermore, although there are no particular restrictions on the blend quantity of the photopolymerization initiator, a quantity within a range from 0.01 to 30 parts by mass per 100 parts by mass of the bifunctional or higher (meth)acrylate compound (C) is usually preferred.

There are no particular restrictions on the above photobase generator, provided it is a compound that generates a base upon irradiation. In terms of the reactivity and curing rate, the base that is generated is preferably a strongly basic compound. Generally, the logarithm of the acid dissociation constant known as the pKa value is used as an indicator of the basicity, and bases for which the pKa value in an aqueous solution is 7 or greater are preferred, and bases with a pKa value of 9 or greater are even more desirable. Examples of compounds that exhibit this type of basicity include imidazole and imidazole derivatives such as 2,4-dimethylimidazole and 1-methylimidazole, piperidine and piperidine derivatives such as 1,2-dimethylpiperidine, proline derivatives, trimethylamine, triethylamine and trialkylamine derivatives such as triethanolamine, pyridine derivatives having an amino group or alkylamino group substituent at position-4, such as 4-methylaminopyridine and 4-dimethylaminopyridine, pyrrolidine and pyrrolidine derivatives such as n-methylpyrrolidine, alicyclic amine derivatives such as triethylenediamine and 1,8-diazabicyclo(5,4,0)undecene-1 (DBU), and benzylamine derivatives such as benzylmethylamine, benzyldimethylamine and benzyldiethylamine.

Examples of compounds that generate a base upon irradiation include the quaternary ammonium derivatives disclosed in Journal of Photopolymer Science and Technology, vol. 12, pp. 313 to 314 (1999) and Chemistry of Materials, vol. 11, pp. 170 to 176 (1999). These compounds generate highly basic trialkylamines upon irradiation with an active light beam, and are therefore ideal for curing epoxy resins. Furthermore, the carbamic acid derivatives disclosed in Journal of American Chemical Society, vol. 118, p. 12925 (1996) and Polymer Journal, vol. 28, p. 795 (1996) can also be used. Furthermore, oxime derivatives that generate a primary amino group upon irradiation with an active light beam, commercially available photoradical generators such as 2-methyl-1-(4-methythio)phenyl)-2-morpholinopropan-1-one (Irgacure 907, manufactured by Ciba Specialty Chemicals, Inc.) and 2-benzyl-2-dimethylamino-1-(4-morpholinophenyl)-butanone-1 (Irgacure 369, manufactured by Ciba Specialty Chemicals, Inc.), hexaarylbisimidazole derivatives (in which the phenyl groups may be substituted with substituent groups such as halogens, alkoxy groups, a nitro group, or a cyano group or the like), and benzisoxazolone derivatives and the like can also be used. Moreover, as an alternative to generating a base by irradiation with an active light beam, a basic compound may be generated, and curing of the epoxy resin then conducted, by employing a photo-Fries rearrangement, a photo-Claisen rearrangement, a Curtius rearrangement, or a Stevens rearrangement.

Furthermore, instead of using a low molecular weight compound with a molecular weight of 500 or less, the above photobase generator may also employ a compound introduced into the principal chain or a side chain of a polymer. In such cases, from the viewpoints of achieving favorable adhesion and fluidity as an adhesive, the weight average molecular weight of the polymer is preferably within a range from 1,000 to 100,000, and even more preferably from 5,000 to 30,000. Because these compounds exhibit no reactivity with epoxy resins at room temperature until subjected to irradiation, they exhibit particularly superior storage stability at room temperature.

When using a photoinitiator (G) described above, the film-like adhesive of the present invention that contains the photoinitiator (G) is irradiated during the semiconductor device assembly process, following completion of the dicing step, thereby causing the acrylate compound (C) and/or the maleimide compound to undergo polymerization curing, thus reducing the adhesive strength at the interface between the film-like adhesive and the substrate, and enabling pickup of the semiconductor element.

Any of the various coupling agents may also be added to the adhesive composition of the present invention in order to improve the interfacial bonding between different materials. Examples of coupling agents include silane-based, titanium-based and aluminum-based coupling agents, and of these, silane-based coupling agents are preferred as they yield the largest effect. From the viewpoints of the effects achieved, the heat resistance and the cost, the quantity used of the coupling agent is preferably within a range from 0.01 to 20 parts by weight per 100 parts by weight of the thermoplastic resin (A).

Ion scavengers may also be added to the adhesive composition of the present invention in order to adsorb ionic impurities incorporated within the composition, and improve the insulation reliability upon moisture absorption. Examples of this type of ion scavenger include compounds such as triazinethiol compounds and bisphenol-based reducing agents, which are known as copper inhibitors for preventing the ionization and elution of copper, as well as inorganic ion adsorbents such as zirconium-based compounds, antimony-bismuth-based magnesium-aluminum compounds. From the viewpoints of the effects achieved, the heat resistance and the cost, the quantity used of these ion scavengers is preferably within a range from 0.01 to 10 parts by weight per 100 parts by weight of the thermoplastic resin (A).

If required, the adhesive composition of the present invention may also include a thermosetting resin different from the bisallylnadimide (B), the bifunctional or higher acrylate compound (C), the maleimide compound and/or a monofunctional condensed polycyclic oxazine compound (D) and the epoxy resin (E). A thermosetting resin is a reactive compound that undergoes a cross-linking reaction upon heating, and examples of this type of compound include cyanate ester resins, phenolic resins, urea resins, melamine resins, alkyd resins, acrylic resins, unsaturated polyester resins, diallyl phthalate resins, silicone resins, resorcinol-formaldehyde resins, xylene resins, furan resins, polyurethane resins, ketone resins, triallyl cyanurate resins, polyisocyanate resins, resins containing tris(2-hydroxyethyl) isocyanurate, resins containing triallyl trimellitate, thermosetting resins synthesized from cyclopentadiene, and thermosetting resins formed by trimerization of aromatic dicyanamides. These thermosetting resins may be used either alone, or in combinations of two or more different resins. Furthermore, a curing agent or catalyst may also be used to promote curing of the thermosetting resin, and if necessary, combinations of a curing agent and a curing accelerator, or a catalyst and a co-catalyst may also be used.

In those cases where a thermosetting resin is used, the blend quantity of the thermosetting resin is adjusted so as to achieve a combination of a low level of out gas and favorable film-forming properties (toughness), and ensure an effective level of heat resistance upon heat curing. The blend quantity is preferably within a range from 0.01 to 100 parts by weight per 100 parts by weight of the thermoplastic resin (A).

Furthermore, suitable quantities of softening agents, age inhibitors, colorants, flame retardants, adhesion-imparting agents such as terpene-based resins, and thermoplastic polymer components may also be added to the adhesive composition of the present invention. Examples of thermoplastic polymer components, which can be used to improve adhesion and impart favorable stress relaxation properties during curing, include polyvinyl butyral resins, polyvinyl formal resins, polyester resins, polyamide resins, polyimide resins, xylene resins, phenoxy resins, polyurethane resins, urea resins and acrylic rubbers. These polymer components preferably have a molecular weight within a range from 5,000 to 500,000.

### (Method of Producing Film-Like Adhesive)

The film-like adhesive of the present invention can be obtained, for example, by preparing a varnish by mixing or kneading the adhesive composition of the present invention described above within an organic solvent, forming a layer of the varnish on top of a substrate film, heating and drying the varnish, and then removing the substrate film. The mixing or kneading can be conducted using a stirrer or dispersion device such as a stone mill, three-roll mill, ball mill, or a combination thereof. Furthermore, there are no particular restrictions on the above heating and drying conditions, provided they enable satisfactory volatilization of the solvent being used, and typical conditions involve heating at 50 to 200° C. for a period of 0.1 to 90 minutes. There are no particular restrictions on the organic solvent, namely the varnish solvent, provided it is capable of uniformly dissolving, mixing or dispersing the adhesive composition of the present invention, and typical examples include dimethylformamide, dimethylacetamide, N-methyl-2-pyrrolidone, dimethylsulfoxide, diethylene glycol dimethyl ether, toluene, benzene, xylene, methyl ethyl ketone, methyl isobutyl ketone, tetrahydrofuran, ethyl cellosolve, ethyl cellosolve acetate, butyl cellosolve, dioxane, cyclohexanone, and ethyl acetate.

There are no particular restrictions on the above substrate film, provided it is able to withstand the heating and drying conditions described above. Examples of such substrate films include polyester films, polypropylene films, polyethylene terephthalate films, polyimide films, polyetherimide films, polyether naphthalate films, and methylpentene films. The substrate film may also be a multilayered film comprising two or more substrate films, which may be either the same or different, laminated together, and the surface of the substrate film may also be treated with a release agent such as a silicone-based release agent.

The thickness of the film-like adhesive of the present invention may be determined in accordance with the intended application or method of use, and although there are no particular restrictions, a thickness value within a range from 1 to 100 μm is preferred.

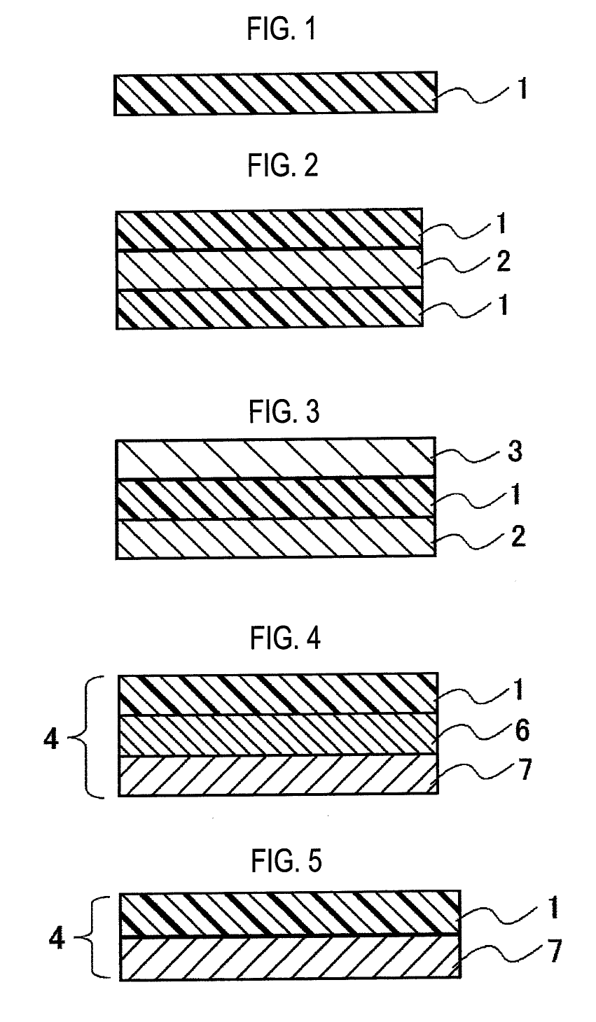

One example of an embodiment of the film-like adhesive of the present invention is a single layer film-like adhesive 1 shown in FIG. 1. In this embodiment, the film-like adhesive is preferably formed as a tape with a width of approximately 1 to 20 mm or a film with a width of approximately 10 to 50 cm, and then wound around a core for transporting. Furthermore, a structure in which a layer of the film-like adhesive 1 is formed on either one surface (not shown in the figures) or both surfaces (see FIG. 2) of a substrate film 2 may also be used. A suitable cover film may also provided on top of the film-like adhesive in order to prevent scratching or soiling of the film-like adhesive, and for example, an embodiment such as that shown in FIG. 3 may be used, wherein a layer of the film-like adhesive 1 is provided on top of the substrate film 2, and a cover film 3 is then provided on top of the film-like adhesive layer.

The present invention is described further below, using a series of preferred embodiments.

A film-like adhesive of the first embodiment of the present invention preferably has a main dispersion peak temperature prior to use (namely, prior to bonding of a semiconductor element to an adherend) of not more than 100° C. This main dispersion peak temperature is even more preferably within a range from −20 to 80° C. The main dispersion peak temperature refers to the tan δ peak temperature in the vicinity of Tg when the film-like adhesive is measured prior to use, using the tensile mode of a viscoelasticity analyzer RSA-2 manufactured by Rheometrics Inc., under conditions including a film-like adhesive sample size of 35 mm×10 mm, a rate of temperature increase of 5° C./minute, a frequency of 1 Hz, and a measurement temperature range from −150 to 300° C. If this main dispersion peak temperature (tan δ peak temperature) is less than −20° C., then the tack of the surface of the film-like adhesive becomes overly strong, and the handling properties tend to deteriorate, whereas if the tan δ peak temperature exceeds 100° C., then the temperature at which the film-like adhesive can be bonded to the backside of a wafer may exceed 100° C. The temperature at which the film-like adhesive of the present invention can be bonded to the backside of a wafer is preferably no higher than the softening temperature of the wafer protective tape and the dicing sheet, and from the viewpoint of suppressing warping of the semiconductor wafer, is even more preferably within a range from 20 to 100° C., even more preferably from 20 to 80° C., and is most preferably from 20 to 60° C. In order to enable bonding to a wafer backside at a temperature within this range, as described above, the Tg value of the film-like adhesive is preferably not more than 100° C., and therefore the Tg value of the thermoplastic resin (A) is preferably not more than 100° C., even more preferably not more than 80° C., even more preferably within a range from −20 to 80° C., and is most preferably from −20 to 60° C. If the Tg value of the thermoplastic resin (A) exceeds 100° C., then the wafer backside bonding temperature is much more likely to exceed 80° C., whereas if the Tg value is lower than −20° C., then the tack of the film surface at the B-stage becomes overly powerful, meaning the handling properties tend to deteriorate.

The film-like adhesive of the first embodiment of the present invention preferably exhibits a flow amount prior to use (namely, prior to bonding of a semiconductor element to an adherend), when subjected to thermocompression on top of a hotplate at 180° C., of at least 1,000 μm. This flow amount is even more preferably 1,500 μm or greater, and although there is no particular restriction on the upper limit, an amount of 4,000 μm or less is desirable. If this flow amount is less than 1,000 μm, then it tends to become difficult to ensure that the film-like adhesive has the required fluidity upon heating to satisfactorily embed the unevenness on top of a wired substrate under the type of heat and pressure applied during de bonding. Furthermore, if the flow amount exceeds 4,000 μm, then the fluidity of the film-like adhesive under the heat and pressure applied during die bonding may become overly large, which not only increases the chance of the adhesive protruding beyond the surface area of the semiconductor element, but tends to increase the chance of the adhesive incorporating air bubbles left between irregularities on the substrate surface, which can cause residual voids within the film-like adhesive layer, and increases the likelihood of foaming caused by these voids during moisture absorption reflow. The flow amount is measured by preparing a sample by forming a film-like adhesive layer of dimensions 10 mm×10 mm×40 μm (thickness) (the margin of error for the thickness was set at ±5 μm, and this margin of error also applies for all following thickness values, but is omitted from the following description) on top of a substrate (a 50 μm PET film), sandwiching the sample between two glass slides (76 mm×26 mm×1.0 to 1.2 mm (thickness), manufactured by Matsunami Glass hid. Ltd.), conducting thermocompression for 90 seconds by applying a surface pressure of 100 kgf/cm² on top of a 180° C. hotplate, and then using a microscope to measure the quantity of adhesive protruding from the four sides of the sample, with the average of these values taken as the flow amount. This flow amount can be readily adjusted, for example by increasing or decreasing the blend quantity of the filler.

Furthermore, another embodiment of the present invention is an adhesive sheet having a structure comprising a film-like adhesive of the present invention laminated to a dicing sheet, with the sheet performing the function of a die bonding film. Examples of the dicing sheet include structures in which a pressure sensitive adhesive layer that acts as the dicing sheet is laminated to a substrate film, as well as substrate films that themselves function as the dicing sheet. More specific examples of the adhesive sheet of the present invention include an adhesive sheet 4 shown in FIG. 4, in which a substrate film 7, a pressure sensitive adhesive layer 6 and a film-like adhesive 1 of the present invention are laminated together in sequence, and an adhesive sheet 4 shown in FIG. 5, comprising a film-like adhesive 1 of the present invention laminated to a substrate film 7. These adhesive sheets of the present invention combine the properties required of both a dicing sheet and a die bonding film, and are integrated adhesive sheets that exhibit the functions of a dicing sheet during dicing, and the functions of a die bonding film during die bonding. In other words, the film-like adhesive of the adhesive sheet of the present invention can be laminated to the backside of a semiconductor wafer under heat, and following dicing, can be picked up as a film-like adhesive-bearing semiconductor element. In these cases, the film-like adhesive of the present invention is preferably formed (precut) in a shape close to the shape of the wafer.

The above pressure sensitive adhesive layer may be either a pressure sensitive layer or a radiation curable layer, although in terms of the ease with which the adhesive strength can be controlled, a radiation curable layer is preferred, as it offers a greater adhesive strength during dicing, but this adhesive strength can then be reduced by irradiation with ultraviolet light (UV) prior to pickup. There are no particular restrictions on this radiation curable pressure sensitive adhesive layer, and any conventional adhesive can be used, provided it exhibits sufficient adhesion to prevent the semiconductor elements from flying off during dicing, and then during the subsequent semiconductor element pickup process, has a low enough adhesive strength to prevent damage to the semiconductor element.

Furthermore, although there are no particular restrictions on the above substrate film, provided it exhibits adequate stretching (typically known as expansion) when tension is applied, a substrate film formed from a polyolefin is preferred.

The adhesive composition and film-like adhesive of the present invention can be used as a die bonding adhesive material for bonding together semiconductor elements such as ICs and LSIs, and adherends including lead frames such as 42-alloy lead frames and copper lead frames; plastic films formed from polyimide resins or epoxy resins or the like; materials prepared by impregnating a substrate such as a glass unwoven fabric with a plastic such as a polyimide resin or epoxy resin and then curing the resin; and support members for mounting semiconductor elements. The adhesive composition and film-like adhesive are particularly ideal as die bonding adhesive materials for bonding semiconductor elements to organic substrates having surface unevenness, such as organic substrates with an organic resist layer provided on the surface, and organic substrates having wiring on the surface.

Furthermore, the adhesive composition and film-like adhesive of the present invention can also be used as an adhesive material for bonding together adjacent semiconductor elements in Stacked-PKG structures, in which a plurality of semiconductor elements are stacked on top of one another.

As follows is a detailed description, based on the drawings, of semiconductor devices that include a film-like adhesive of the present invention, as examples of potential applications of the film-like adhesive of the present invention. However, in recent years, semiconductor devices of all manner of structures have been proposed, and the applications of the film-like adhesive of the present invention are in no way limited to semiconductor devices with the structures described below.

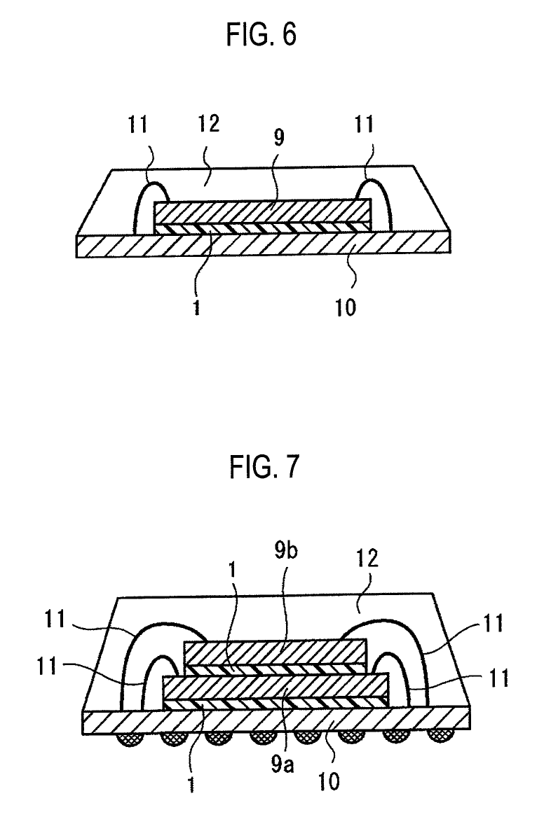

FIG. 6 shows a semiconductor device with a typical structure. In FIG. 6, a semiconductor element 9 is bonded to a semiconductor-mounting support member 10 via a film-like adhesive 1 of the present invention, the connection terminals (not shown in the drawing) of the semiconductor element 9 are connected electrically to external connection terminals (not shown in the drawing) by wires 11, and the entire structure is encapsulated within an encapsulating material 12.

Furthermore, FIG. 7 shows an example of a semiconductor device having a structure in which semiconductor elements are bonded together. In FIG. 7, a first stage semiconductor element 9a is bonded to a semiconductor-mounting support member 10 via a film-like adhesive 1 of the present invention, and a second stage semiconductor element 9b is bonded to the top of the first stage semiconductor element 9a via another layer of the film-like adhesive 1 of the present invention. The connection terminals (not shown in the drawing) of the first stage semiconductor element 9a and the second stage semiconductor element 9b are connected electrically to external connection terminals by wires 11, and the entire structure is encapsulated within an encapsulating material 12. In this manner, the film-like adhesive of the present invention can also be used favorably within structures in which a plurality of semiconductor elements are stacked together.

The semiconductor devices (semiconductor packages) with the structures shown above can be produced via a series of steps comprising: sandwiching the film-like adhesive of the present invention between the semiconductor element and the semiconductor-mounting support member, bonding the two components together by thermocompression bonding, subsequently conducting wire bonding, and then encapsulating the structure within an encapsulating material if required. The heating temperature during the thermocompression bonding step is typically within a range from 20 to 250° C., the load is typically within a range from 0.01 to 20 kgf, and the heating time is typically within a range from 0.1 to 300 seconds.

### EXAMPLES

As follows is a description of specifics of the present invention, based on a series of examples, although the present invention is in no way limited by these examples.

### <Synthesis of Polyimide Resins (PI)>

### (PI-1)

A 300 ml flask fitted with a thermometer, a stirrer, a cooling tube and a nitrogen inlet tube was charged with 2.71 g (0.045 mols) of 1,12-diaminododecane, 5.77 g (0.01 mols) of a polyetherdiamine (D2000, manufactured by BASF corporation (molecular weight: 1923)), 3.35 g (0.045 mols) of 1,3-bis(3-aminopropyl)tetramethyldisiloxane (LP-7100, manufactured by Shin-Etsu Chemical Co., Ltd.) and 113 g of N-methyl-2-pyrrolidone, and the resulting reaction liquid was stirred. Once the 1,12-diaminododecane and the polyetherdiamine had dissolved, the flask was cooled in an ice bath, and 15.62 g (0.1 mols) of 4,4′-(4,4′-isopropylidenediphenoxy)bis(phthalic dianhydride) that had been purified by recrystallization from acetic anhydride (the difference between the endothermic start temperature and the endothermic peak temperature, determined by DSC, was 5.0° C.) was added gradually to the flask. Following reaction for 8 hours at room temperature, 75.5 g of xylene was added, and by heating the reaction mixture to 180° C. while nitrogen gas was blown through the system, the water and xylene were removed by azeotropic distillation. The resulting reaction liquid was poured into a large quantity of water, and the precipitated polymer was collected by filtration and then dried, yielding a polyimide resin (PI-1). Measurement of the thus obtained polyimide resin by GPC with reference against polystyrene standards revealed Mw=53,800 and Mn=17,300. Furthermore, the Tg value of the obtained polyimide resin was 22° C.

### (PI-2)

A 300 ml flask fitted with a thermometer, a stirrer, a cooling tube and a nitrogen inlet tube was charged with 2.10 g (0.035 mols) of 1,12-diaminododecane, 17.31 g (0.03 mols) of a polyetherdiamine (D2000, manufactured by BASF corporation (molecular weight: 1923)), 2.61 g (0.035 mols) of 1,3-bis(3-aminopropyl)tetramethyldisiloxane (LP-7100, manufactured by Shin-Etsu Chemical Co., Ltd.) and 113 g of N-methyl-2-pyrrolidone, and the resulting reaction liquid was stirred. Once the 1,12-diaminododecane and the polyetherdiamine had dissolved, the flask was cooled in an ice bath, and 15.62 g (0.1 mols) of 4,4′-(4,4′-isopropylidenediphenoxy)bis(phthalic dianhydride) that had been purified by recrystallization from acetic anhydride (the difference between the endothermic start temperature and the endothermic peak temperature, determined by DSC, was 5.0° C.) was added gradually to the flask. Following reaction for 8 hours at room temperature, 75.5 g of xylene was added, and by heating the reaction mixture to 180° C. while nitrogen gas was blown through the system, the water and xylene were removed by azeotropic distillation. The resulting reaction liquid was poured into a large quantity of water, and the precipitated polymer was collected by filtration and then dried, yielding a polyimide resin (PI-2). Measurement of the thus obtained polyimide resin by GPC with reference against polystyrene standards revealed Mw=70,000 and Mn=20,800. Furthermore, the Tg value of the obtained polyimide resin was 53° C.

### (PI-3)

A 300 ml flask fitted with a thermometer, a stirrer, a cooling tube and a nitrogen inlet tube was charged with 32.60 g (0.1 mols) of a polyetherdiamine (D400, manufactured by BASF corporation (molecular weight: 452.4)) and 105 g of N-methyl-2-pyrrolidone, and the resulting reaction liquid was stirred. Once the polyetherdiamine had dissolved, the flask was cooled in an ice bath, and 37.40 g (0.1 mols) of 4,4′-(4,4′-isopropylidenediphenoxy)bis(phthalic dianhydride) that had been purified by recrystallisation from acetic anhydride (the difference between the endothermic start temperature and the endothermic peak temperature, determined by DSC, was 5.0° C.) was added gradually to the flask. By heating the reaction mixture for 5 hours at 170° C. while nitrogen gas was blown through the system, the generated water was removed by distillation. The resulting reaction liquid was poured into a large quantity of water, and the precipitated polymer was collected by filtration and then dried, yielding a polyimide resin (PI-3). Measurement of the thus obtained polyimide resin by GPC with reference against polystyrene standards revealed Mw=72,000 and Mn=34,000. Furthermore, the Tg value of the obtained polyimide resin was 37° C.

### (PI-4)

A 300 ml flask fitted with a thermometer, a stirrer, and a calcium chloride tube was charged with 6.83 g (0.05 mols) of 2,2-bis(4-aminophenoxyphenyl)propane, 3.40 g (0.05 mols) of 4,9-dioxadecane-1,12-diamine, and 110.5 g of N-methyl-2-pyrrolidone, and the resulting mixture was stirred. Once the diamine had dissolved, the flask was cooled in an ice bath, and 17.40 g (0.10 mols) of decamethylene bistrimellitate dianhydride that had been purified by recrystallization from acetic anhydride (the difference between the endothermic start temperature and the endothermic peak temperature, determined by DSC, was 5.0° C.) was added gradually to the flask. Following reaction for 8 hours at room temperature, 74 g of xylene was added, and by heating the reaction mixture to 180° C. while nitrogen gas was blown through the system, the water and xylene were removed by azeotropic distillation. The resulting reaction liquid was poured into a large quantity of water, and the precipitated polymer was collected by filtration and then dried, yielding a polyimide resin (PI-3). Measurement of the thus obtained polyimide resin by GPC with reference against polystyrene standards revealed Mw=88,600 and Mn=28,900. Furthermore, the Tg value of the obtained polyimide resin was 73° C.

### (PI-5)

A 300 ml flask fitted with a thermometer, a stirrer, a cooling tube and a nitrogen inlet tube was charged with 13.67 g (0.1 mols) of 2,2-bis(4-aminophenoxyphenyl)propane and 124 g of N-methyl-2-pyrrolidone, and the resulting mixture was stirred. Once the diamine had dissolved, the flask was cooled in an ice bath, and 17.40 g (0.10 mols) of decamethylene bistrimellitate dianhydride that had been purified by recrystallization from acetic anhydride (the difference between the endothermic start temperature and the endothermic peak temperature, determined by DSC, was 5° C.) was added gradually to the flask. Following reaction for 8 hours at room temperature, 83 g of xylene was added, and by heating the reaction mixture to 180° C. while nitrogen gas was blown through the system, the water and xylene were removed by azeotropic distillation. The resulting reaction liquid was poured into a large quantity of water, and the precipitated polymer was collected by filtration and then dried, yielding a polyimide resin (PI-4). Measurement of the thus obtained polyimide resin by GPC with reference against polystyrene standards revealed Mw=121,000 and Mn=22,800. Furthermore, the Tg value of the obtained polyimide resin was 120° C.

### <Preparation of Adhesive Compositions>

Using each of the polyimide resins PI-1 to PI-5 obtained above, adhesive composition varnishes were prepared using the blend formulations shown below in Table 1 and Table 2. In Table 1 and 2, the various symbols have the meanings described below.

ESCN-195: a cresol novolak-based solid epoxy resin (epoxy equivalence: 200), manufactured by Sumitomo Chemical Co., Ltd.
BANI-H: a compound of the structural formula (13) shown below (a hexamethylene bisallylnadimide), manufactured by Maruzen Petrochemical Co., Ltd.

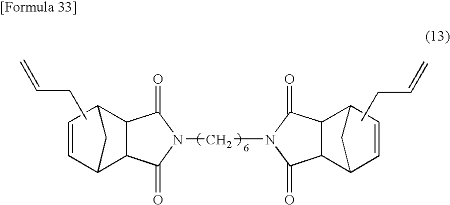

BANI-X: a compound of the structural formula (14) shown below (a xylylene bisallylnadimide), manufactured by Maruzen Petrochemical Co., Ltd.

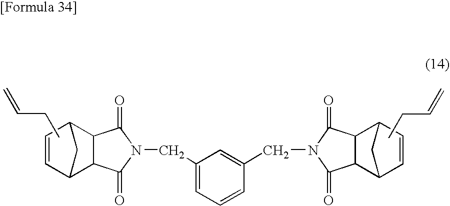

BMI-1000: a compound of the structural formula (15) shown below (4,4′-diphenylmethane bismaleimide), manufactured by Wako Pure Chemical Industries, Ltd.

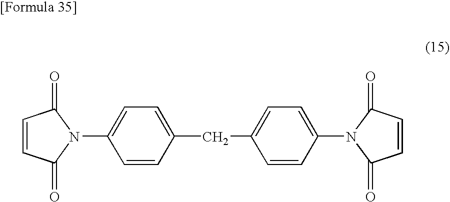

BMI-2000: a compound of the structural formula (16) shown below (a novolak maleimide compound, molecular weight: 366.26), manufactured by Daiwa Fine Chemicals Co., Ltd.

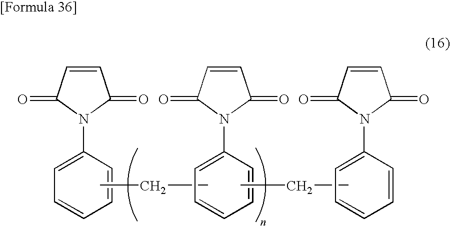

R-712: a compound of the structural formula (17) shown below (an ethoxylated bisphenol F diacrylate), manufactured by Nippon Kayaku Co., Ltd.

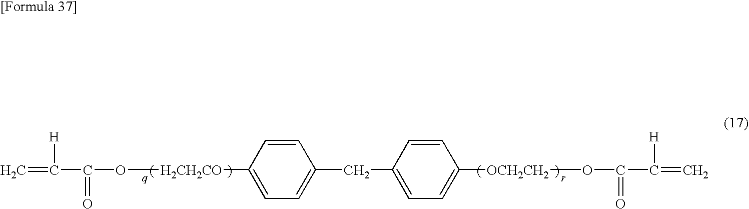

(wherein, q+r=4)
ABE-300: a compound of the structural formula (18) shown below (an ethoxylated bisphenol A diacrylate), manufactured by Shin-Nakamura Chemical Co., Ltd.

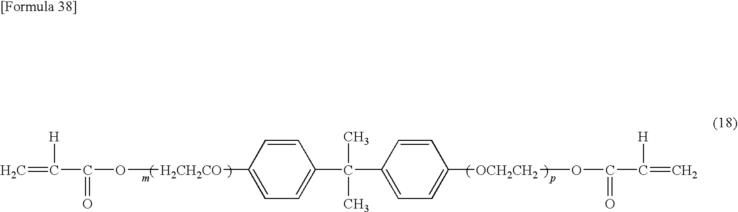

(wherein, m+p=3)
RO-X5: a compound of the structural formula (19) shown below (a benzoxazine compound), manufactured by Hitachi Chemical Co., Ltd.

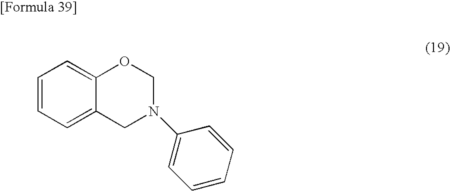

H-1: a phenol novolak resin (OH equivalent weight: 103), manufactured by Meiwa Plastic Industries, Ltd.
TPPK: tetraphenylphosphonium tetraphenylborate, manufactured by Tokyo Chemical Industry Co., Ltd.
NMP: N-methyl-2-pyrrolidone, manufactured by Kanto Chemical Co., Inc.
MEK: methyl ethyl ketone, manufactured by Kanto Chemical Co., Inc.
HP-P1: boron nitride (average particle size: 1.0 μm, maximum particle size: 5.1 μm), manufactured by Mizushima Ferroalloy Co., Ltd.

TABLE 1

| Component | Example 1 | Example 2 | Example 3 | Example 4 | Example 5 | Example 6 | Example 7 | Example 8 | Example 9 |
|---|---|---|---|---|---|---|---|---|---|
| Base resin | PI-1 | PI-1 | PI-1 | PI-1 | PI-1 | PI-1 | PI-1 | PI-2 | PI-3 |
| (parts by weight) | (100) | (100) | (100) | (100) | (100) | (100) | (100) | (100) | (100) |
| Bisallylnadimide | BANI-H | BANI-H | BANI-H | BANI-H | BANI-H | BANI-H | BANI-X | BANI-H | BANI-X |
| (parts by weight) | (10) | (10) | (10) | (10) | (10) | (10) | (10) | (10) | (10) |
| Acrylate compound | R-712 | R-712 | R-712 | ABE-300 | R-712 | R-712 | R-712 | R-712 | R-712 |
| (parts by weight) | (10) | (10) | (10) | (10) | (10) | (10) | (10) | (10) | (10) |
| Maleimide | — | BMI2000 | BMI2000 | BMI1000 | — | — | — | BMI2000 | BMI2000 |
| compound | | (20) | (20) | (20) | | | | (20) | (20) |
| (parts by weight) | | | | | | | | | |
| Benzoxazine | — | — | — | — | RO-X5 | RO-X5 | — | — | — |
| compound | | | | | (20) | (20) | | | |
| (parts by weight) | | | | | | | | | |
| Epoxy resin | — | — | ESCN195 | — | — | ESCN195 | — | ESCN195 | ESCN195 |
| (parts by weight) | | | (20) | | | (20) | | (20) | (20) |
| Filler | HP-P1 | HP-P1 | HP-P1 | HP-P1 | HP-P1 | HP-P1 | HP-P1 | HP-P1 | HP-P1 |
| (% by volume) | (10) | (10) | (10) | (10) | (10) | (10) | (10) | (10) | (10) |
| Coating solvent | NMP (195) | NMP (230) | NMP (265) | NMP (230) | NMP (230) | NMP (265) | NMP (196) | NMP (265) | NMP (265) |
| (parts by weight) | MEK (85) | MEK (100) | MEK (110) | MEK (100) | MEK (100) | MEK (110) | MEK (84) | MEK (110) | MEK (110) |

TABLE 2

| | Comparative | Comparative | Comparative | Comparative | Comparative | Comparative | Comparative | Comparative |
|---|---|---|---|---|---|---|---|---|
| Component | example 1 | example 2 | example 3 | example 4 | example 5 | example 6 | example 7 | example 8 |
| Base resin | PI-1 | PI-1 | PI-1 | PI-1 | PI-1 | PI-2 | PI-4 | PI-5 |
| (parts by weight) | (100) | (100) | (100) | (100) | (100) | (100) | (100) | (100) |
| Epoxy resin | — | ESCN195 | ESCN195 | ESCN195 | ESCN195 | ESCN195 | ESCN195 | — |
| (parts by weight) | | (13.1) | (26.2) | (20) | (40) | (26.2) | (26.2) | |
| Curing agent | — | H-1 | H-1 | — | — | H-1 | H-1 | — |
| (parts by weight) | | (6.8) | (13.6) | | | (13.6) | (13.6) | |
| Curing accelerator | — | TPPK | TPPK | — | — | TPPK | TPPK | — |
| (parts by weight) | | (0.1) | (0.2) | | | (0.2) | (0.2) | |
| Filler | HP-P1 | HP-P1 | HP-P1 | HP-P1 | HP-P1 | HP-P1 | HP-P1 | HP-P1 |
| (% by volume) | (10) | (10) | (10) | (10) | (10) | (10) | (10) | (10) |
| Coating solvent | MEK | NMP | NMP | NMP | NMP | NMP | NMP | NMP |
| (parts by weight) | (300) | (280) | (330) | (280) | (330) | (420) | (420) | (420) |

### <Production and Evaluation of Film-like Adhesives>

The adhesive composition varnishes prepared in the above examples 1 to 9 and comparative examples 1 to 8 were each applied to a substrate (a PET substrate film of thickness 50 μm that had undergone a surface release treatment) in sufficient quantity to generate a coating thickness of 40 μm, and the resulting structures were then heated in an oven for 30 minutes at 80° C., and then for a further 30 minutes at 120° C. if the varnish solvent was either solely MEK or a NMP/MEK mixture, or for a further 30 minutes at 150° C. if the varnish solvent was solely NMP, thus yielding a series of substrate-bonded film-like adhesives. The results of evaluating the properties of each film-like adhesive are shown in Tables 3 and 4. The items evaluated and the evaluation methods used are described below.

Main Dispersion Peak Temperature

The film-like adhesive prior to use (namely, prior to curing, hereafter referred to as the B-stage) was measured using a viscoelasticity analyzer RSA-2 manufactured by Rheometrics Inc., under conditions including a film-like adhesive sample size of 35 mm (length)×10 mm (width)×40 μm (thickness), a rate of temperature increase of 5° C./minute, a frequency of 1 Hz, and a measurement temperature range from −150 to 300° C., and the value of the tan δ peak temperature in the vicinity of Tg was measured and recorded as the main dispersion temperature for the film-like adhesive.

Wafer Backside Bonding Temperature (Chip Flying Upon Dicing)

The substrate-bonded film-like adhesive was laminated to the backside of a 5-inch silicon wafer of thickness 300 μm, using an apparatus containing a support and a roller, under conditions including a roller temperature of 25° C., 40° C., 50° C., 60° C., 70° C., 80° C., 90° C., 100° C., 110° C., 120° C., 130° C., 140° C., 150° C., 160° C., 170° C. or 180° C., a linear pressure of 4 kgf/cm, and a feed rate of 0.5 m/minute, and the substrate was then peeled off the film-like adhesive, yielding a film-like adhesive-bearing wafer. Subsequently, a pressure sensitive releasable dicing sheet having a pressure sensitive adhesive layer formed on top of a substrate film (AD-80H, manufactured by Denki Kagaku Kogyo Kabushiki Kaisha, thickness: 80 μm) was bonded to the opposite surface of the film-like adhesive from that contacting the wafer, so that the pressure sensitive adhesive layer and the film-like adhesive were in direct contact. Subsequently, a dicer was used to dice the silicon wafer into chips with dimensions of 5 mm×5 mm, under conditions including a dicing speed of 10 mm/s and a rotational speed of 30,000 rpm, and the level of chip flying during the dicing process was observed. If the number of flying chips was not more than 10% of the total number of chips, then the chip flying evaluation was recorded as “none”, and the lowest lamination temperature for which a chip flying evaluation of “none” could be obtained was recorded as the wafer backside bonding temperature. Dicing residual portions at the edge of the wafer were excluded from the chip flying evaluation.

Flow Amount

A substrate-bonded film-like adhesive (prior to use) with dimensions of 10 mm×10 mm×40 μm (thickness) was prepared as a sample, and this sample was sandwiched between two glass slides (76 mm×26 mm×1.0 to 1.2 mm (thickness), manufactured by Matsunami Glass Ind. Ltd.), and then subjected to thermocompression for 90 seconds by applying a surface pressure of 100 kgf/cm² on top of a 180° C. hotplate. A calibrated optical microscope was then used to measure the quantity of adhesive protruding from the four sides of the substrate film, and the average of these values was recorded as the flow amount.

Film Surface Tack Strength

Using a Probe Tackiness Tester manufactured by Rhesca Co., Ltd., the tack strength (adhesive strength) at 40° C. of the upper surface of the B-stage film-like adhesive (thickness: 40 μm) was measured in accordance with the method disclosed in JIS 20237-1991 (probe diameter: 5.1 mm, peel speed: 10 mm/s, contact load: 100 gf/cm², contact time: 1 second).

25° C. Elastic Modulus

The storage elastic modulus at 25° C. for the B-stage film-like adhesive was estimated using a viscoelasticity analyzer RSA-2 manufactured by Rheometrics Inc., by measuring an adhesive layer sample of size 35 mm (length)×10 mm (width)×40 μm (thickness) under conditions including a rate of temperature increase of 5° C./minute, a frequency of 1 Hz, and a measurement temperature range from −150 to 300° C.

100° C. Melt Viscosity

Between 3 and 7 B-stage film-like adhesive layers of thickness 40 μm were superimposed and bonded together to form a film sample with a thickness of 100 to 300 μm, and using a Rotational Rheometer ARES manufactured by Rheometric Scientific Inc., this film sample was sandwiched between two parallel plates (diameter: 8 mm) using a gap separation that was 2 to 5 μnarrower than the thickness of the film sample, and then measured under conditions including a frequency of 1 Hz, a strain of 5%, a rate of temperature increase of 5/minute, and a measurement temperature range of 30 to 300° C., and the measured value for the complex viscosity at 100° C. was recorded as the 100° C. melt viscosity.

260° C. Elastic Modulus

The storage elastic modulus at 260° C. for the C-stage film-like adhesive (formed by heat curing the prepared film in an oven for 5 hours at 180° C.) was estimated using a viscoelasticity analyzer RSA-2 manufactured by Rheometrics Inc., by measuring an adhesive layer sample of size 35 mm (length)×10 mm (width)×40 μm (thickness) under conditions including a rate of temperature increase of 5° C./minute, a frequency of 1 Hz, and a measurement temperature range from −150 to 300° C.

Peel Strength

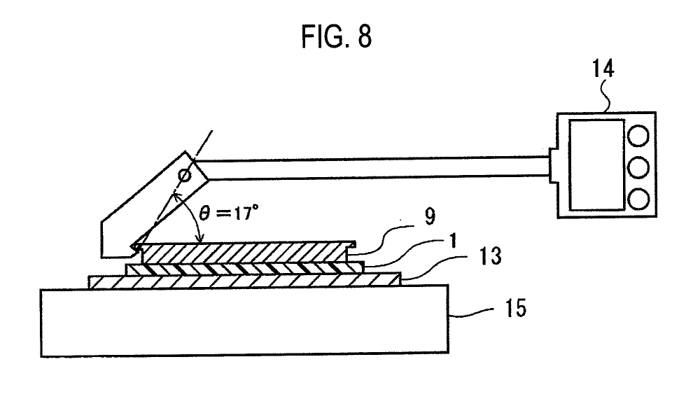

The film-like adhesive (5 mm×5 mm×40 μm (thickness)) was used to die bond a silicon chip (a semiconductor element: 5 mm×5 mm×0.4 mm (thickness)) to the surface of an organic substrate (thickness: 0.1 mm) having a solder resist layer (thickness: 15 μm) formed thereon, under conditions including a temperature 100° C. greater than the Tg value for the polyimide resin that constitutes the film-like adhesive, a pressure of 500 gf/chip, and a bonding time of 3 seconds, and the structure was then subjected to thermocompression bonding under conditions including a temperature of 180° C., a pressure of 5 kgf/chip and a bonding time of 90 seconds to simulate the heat and pressure associated with transfer molding. The test piece was then heat cured in an oven for 5 hours at 180° C., and following further heating for 20 seconds on top of a 260° C. hotplate, the adhesive strength evaluation apparatus shown in FIG. 8 (13: lead frame, 14: push-pull gauge, 15: hotplate) was used to measure the peel strength between the silicon chip and the film-like adhesive at a measurement speed of 0.5 mm/s, and this value was reported as the peel strength.

TABLE 3

| Item | Example 1 | Example 2 | Example 3 | Example 4 | Example 5 | Example 6 | Example 7 | Example 8 | Example 9 |
|---|---|---|---|---|---|---|---|---|---|
| Main dispersion | 6 | 8 | 11 | 8 | 12 | 13 | 9 | 45 | 45 |
| temperature (° C.) | | | | | | | | | |
| Wafer backside bonding | 25 | 25 | 25 | 25 | 25 | 25 | 25 | 25 | 60 |
| temperature (° C.) | | | | | | | | | |
| Flow amount | 2,850 | 2,500 | 2,200 | 2,400 | 2,700 | 2,350 | 1,590 | 1,850 | 1,750 |
| (μm) | | | | | | | | | |
| Film surface tack | 200 | 193 | 190 | 190 | 195 | 200 | 105 | 183 | 9 |
| strength (gf) | | | | | | | | | |
| 25° C. elastic modulus | 800 | 1,000 | 900 | 200 | 110 | 1,100 | 300 | 3 | 1,000 |
| (MPa) | | | | | | | | | |
| 100° C. melt viscosity | 800 | 900 | 980 | 910 | 900 | 1,000 | 800 | 1,000 | 2,800 |
| (Pa · s) | | | | | | | | | |
| 260° C. elastic modulus | 0.1 | 0.2 | 5.3 | 5.5 | 0.2 | 5.4 | 0.1 | 5.4 | 5.0 |
| (MPa) | | | | | | | | | |
| Peel strength | 10.0 | 18.0 | 27.0 | 15.0 | 20.0 | 28.0 | 17.0 | 32.0 | 30.0 |
| (N/chip) | | | | | | | | | |

TABLE 4

| | Comparative | Comparative | Comparative | Comparative | Comparative | Comparative | Comparative | Comparative |
|---|---|---|---|---|---|---|---|---|
| Component | example 1 | example 2 | example 3 | example 4 | example 5 | example 6 | example 7 | example 8 |
| Main dispersion | 22 | 21 | 24 | 22 | 23 | 54 | 81 | 120 |
| temperature (° C.) | | | | | | | | |
| Wafer backside | 60 | 60 | 60 | 60 | 60 | 80 | 100 | 150 |
| bonding temperature | | | | | | | | |
| (° C.) | | | | | | | | |
| Flow amount | 2,700 | 720 | 520 | 560 | 290 | 440 | 280 | 150 |
| (μm) | | | | | | | | |
| Film surface tack | 180 | 56 | 60 | 60 | 48 | 6 | 1 | 1 |
| strength (gf) | | | | | | | | |
| 25° C. elastic modulus | 100 | 110 | 120 | 120 | 110 | 1,000 | 3,000 | 2,000 |
| (MPa) | | | | | | | | |
| 100° C. melt viscosity | 1,200 | 51,000 | 52,000 | 50,000 | 49,000 | 51,000 | 55,000 | 53,000 |
| (Pa · s) | | | | | | | | |
| 260° C. elastic | Melt flow | 0.6 | 1.2 | 1.1 | 0.8 | 8.0 | 70 | Melt flow |
| modulus (MPa) | | | | | | | | |
| Peel strength | 0.2 | 11.2 | 4.4 | 9.3 | 2.4 | 19.2 | 25.0 | 1.5 |
| (N/chip) | | | | | | | | |

As shown in Tables 3 and 4, the film-like adhesives (adhesive sheets) obtained using the adhesive compositions of the examples 1 through 9 all exhibited peel strength values of at least 10 N/chip, suffered minimal chip flying during dicing, and were able to suppress the backside bonding temperature to a low value. Furthermore, because the flow amount was within a range from 1,000 to 3,000 μm for all of the compositions, it is thought that the compositions should exhibit excellent fill properties (embedability) for adherends, and also be resistant to resin protrusion and void generation.

1. An adhesive composition used for bonding a semiconductor element to an adherend, the composition comprising: (A) a thermoplastic resin, (B) a bisallylnadimide represented by a general formula (I) shown below, and (C) a bifunctional or higher (meth)acrylate compound: 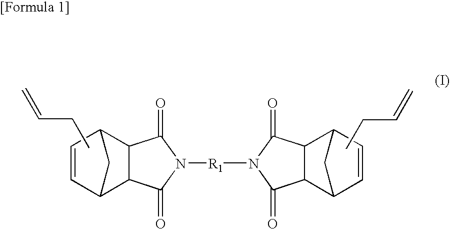
(wherein, R₁ represents a bivalent organic group containing an aromatic ring and/or a straight-chain, branched or cyclic aliphatic hydrocarbon).

2. The adhesive composition according to claim 1, wherein the bisallylnadimide (B) is represented by a structural formula (II) and/or structural formula (III) shown below.

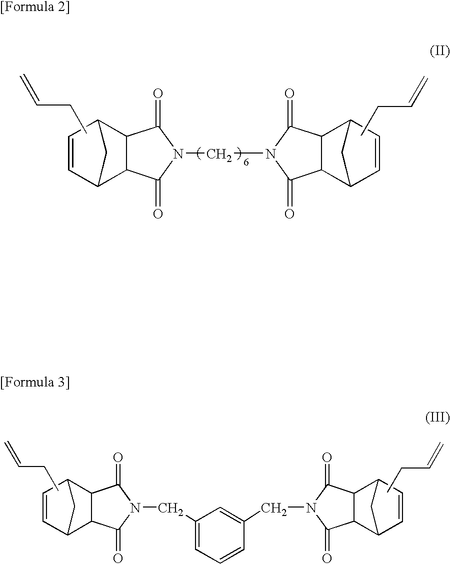

3. The adhesive composition according to claim 1, wherein the bifunctional or higher (meth)acrylate compound (C) is represented by a structural formula (IV) shown below: 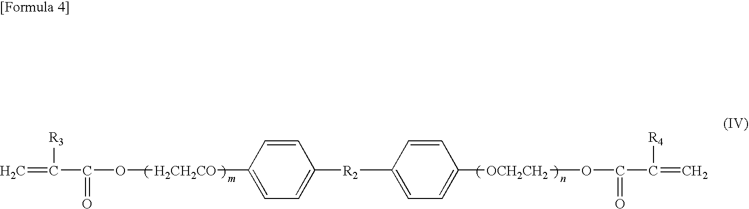
(wherein, R₂ represents a bivalent organic group, R₃ and R₄ each represent, independently, a hydrogen atom or a methyl group, and m and n represent integers of 1 or greater).

4. The adhesive composition according to claim 1, further comprising: (D) a maleimide compound and/or a monofunctional condensed polycyclic oxazine compound.

5. The adhesive composition according to claim 4, wherein the maleimide compound is a bismaleimide compound represented by a general formula (V) shown below, or a novolak maleimide compound represented by a general formula (VI) shown below: 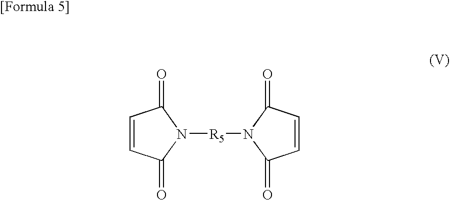
(wherein, R₅ represents a bivalent organic group containing an aromatic ring and/or a straight-chain, branched or cyclic aliphatic hydrocarbon), 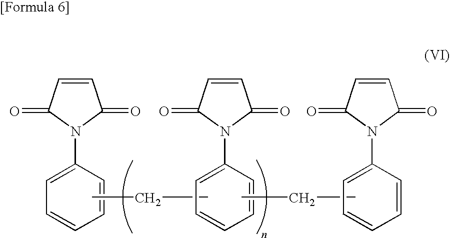
(wherein, n represents an integer from 0 to 20).

6. The adhesive composition according to claim 4, wherein the monofunctional condensed polycyclic oxazine compound is a compound represented by a general formula (VII) shown below: 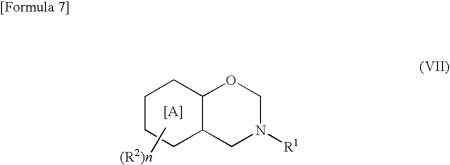
(wherein, [A] represents a monocyclic or condensed polycyclic aromatic hydrocarbon ring structure in which adjacent carbon atoms are shared with the oxazine ring to form a condensed ring structure, R¹ and R² are each selected, independently, from the group consisting of a hydrogen atom and substituted or unsubstituted monovalent hydrocarbon groups of 1 to 10 carbon atoms, all the R¹ and R² groups are either identical or different, and n represents either 0, or an integer from 1 to 4).

7. The adhesive composition according to claim 6, wherein the monofunctional condensed polycyclic oxazine compound represented by the above general formula (VII) is a compound represented by a general formula (VIII) shown below: 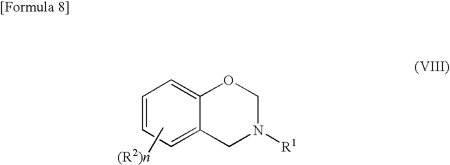
(wherein, R¹ and R² are each selected, independently, from the group consisting of a hydrogen atom and substituted or unsubstituted monovalent hydrocarbon groups of 1 to 10 carbon atoms, all the R¹ and R² groups are either identical or different, and n represents either 0, or an integer from 1 to 4).

8. The adhesive composition according to claim 1, further comprising: (E) an epoxy resin.

9. The adhesive composition according to claim 1, further comprising: (F) a filler.

10. The adhesive composition according to claim 1, wherein the thermoplastic resin (A) is a polyimide resin.

11. The adhesive composition according to claim 10, wherein the polyimide resin is a polyimide resin obtained by reacting a tetracarboxylic dianhydride with a diamine comprising an aliphatic ether diamine represented by a formula (IXb) shown below: 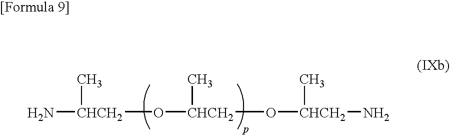
(wherein, p represents an integer from 0 to 80).

12. The adhesive composition according to claim 10, wherein a Tg value for the polyimide resin is not higher than 100° C.

13. The adhesive composition according to claim 1, further comprising: (G) a photoinitiator.

14. The adhesive composition according to claim 1, wherein the adherend is an organic substrate having wiring unevenness.

15. A film-like adhesive, formed using the adhesive composition according to claim 1.

16. An adhesive sheet, having a structure comprising the film-like adhesive according to claim 15 and a dicing sheet laminated together.

17. The adhesive sheet according to claim 16, wherein the dicing sheet comprises a substrate film, and a radiation curable pressure sensitive adhesive layer provided on top of the substrate film.

18. The adhesive sheet according to claim 16, wherein the dicing sheet is a polyolefin-based film.

19. A semiconductor device, having a structure in which a semiconductor element and a support member for mounting a semiconductor element, and/or a semiconductor element and another semiconductor element, are bonded together using the adhesive composition according to claim 1.

20. A semiconductor device, having a structure in which a semiconductor element and a support member for mounting a semiconductor element, and/or a semiconductor element and another semiconductor element, are bonded together using the film-like adhesive according to claim 15.

21. The adhesive composition according to claim 4, further comprising: (E) an epoxy resin.

22. The adhesive composition according to claim 21, further comprising: (F) a filler.

23. The adhesive composition according to claim 22, further comprising: (G) a photoinitiator.
